(19) United States
(12) Patent Application Publication
(10) Pub. No.: US 2026/0066826 A1
(43) Pub. Date: Mar. 5, 2026

(54) INVERTER CONTROL APPARATUS AND SYNCHRONOUS MACHINE DRIVING APPARATUS

(71) Applicants: KABUSHIKI KAISHA TOSHIBA, Tokyo (JP); Toshiba Industrial Products and Systems Corporation, Kawasaki-shi (JP)

(72) Inventors: Tomoaki SHIGETA, Fuchu Tokyo (JP); Makoto MATSUSHITA, Fuchu Tokyo (JP)

(73) Assignees: KABUSHIKI KAISHA TOSHIBA, Tokyo (JP); Toshiba Industrial Products and Systems Corporation, Kawasaki-shi (JP)

(21) Appl. No.: 19/243,846

(22) Filed: Jun. 20, 2025

(30) Foreign Application Priority Data
Aug. 29, 2024 (JP) 2024-147998

(51) Int. Cl. H02P 27/06; H02P 21/14; H02P 25/022

(52) U.S. Cl. CPC H02P 27/06; H02P 21/14; H02P 25/022

(57) ABSTRACT

According to an embodiment, an inverter control apparatus includes a voltage command generation unit that generates a voltage command to be applied to a synchronous machine; a current detector that detects a current flowing from an inverter main circuit to the synchronous machine; a flag generation unit that switches between a motor parameter tuning operation and a normal driving operation; and a parameter arithmetic unit that calculates a motor parameter using a value of the voltage command and a detection value of the current detector at a time of a motor parameter tuning operation. The voltage command generation unit generates the voltage command to apply a DC voltage to the synchronous machine at a time of motor parameter tuning operation.

### CROSS-REFERENCE TO RELATED APPLICATIONS

This application is based upon and claims the benefit of priority from Japanese Patent Application No. 2024-147998, filed Aug. 29, 2024 the entire contents of which are incorporated herein by reference.

### FIELD

Embodiments described herein relate generally to an inverter control apparatus and a synchronous machine driving apparatus.

### BACKGROUND

When the synchronous machine is driven using the inverter, a motor parameter is required. In the related art, in addition to a method of acquiring data such as motor winding resistance and inductance by a preliminary test and acquiring a motor parameter of a synchronous machine, an automatic acquisition (automatic tuning) method has been proposed. According to the autotuning, a preliminary test for data acquisition is unnecessary, and the time until the start of synchronous machine operation can be shortened.

For example, there have been proposed a method of applying a three-phase unbalanced AC voltage to a synchronous machine and acquiring a motor parameter (motor winding resistance, inductance) from a frequency component of the AC current, a method of superimposing a high frequency signal on a signal applied to the synchronous machine and observing a response thereof to acquire a differential inductance corresponding to a harmonic and calculating an average inductance corresponding to a fundamental wave therefrom to acquire a motor parameter, a method of applying a DC current and an AC current to the synchronous machine to calculate a motor parameter, and the like.

However, in the method of applying the three-phase unbalanced AC voltage to the synchronous machine, when the frequency of the AC voltage is lowered, the synchronous machine easily rotates, and when the frequency is raised, noise is generated. Therefore, it is difficult to stably acquire the motor parameter, and there is a possibility that the reliability is lowered. In addition, in a case where a high frequency signal is applied to a synchronous machine, vibration may occur in addition to noise caused by superimposition of the high frequency signal.

### BRIEF DESCRIPTION OF THE DRAWINGS

FIG. 1 is a diagram schematically illustrating a configuration example of an inverter control apparatus and a synchronous machine driving apparatus according to the first embodiment.

FIG. 2 is a diagram schematically illustrating an example of a synchronous machine driven by the synchronous machine driving apparatus according to an embodiment.

FIG. 3 is a diagram for describing a definition of a rotation coordinate system (d axis, q axis) and an estimation rotation coordinate system (dc axis, qc axis) in an embodiment.

FIG. 4 is a diagram schematically illustrating a configuration example of a flag generation unit illustrated in FIG. 1.

FIG. 5 is a diagram schematically illustrating a configuration example of a rotation determination unit illustrated in FIG. 4.

FIG. 6 is a diagram schematically illustrating an example of a flag generated by the generation unit.

FIG. 7 is a block diagram schematically illustrating a configuration example of a parameter calculation function unit of the voltage command generation unit.

FIG. 8 is a block diagram schematically illustrating a configuration example of a normal driving function unit of the voltage command generation unit.

FIG. 9 is a diagram schematically illustrating a configuration example of a high frequency voltage superimposition unit illustrated in FIG. 1.

FIG. 10 is a diagram schematically illustrating a configuration example of a rotation angle/speed arithmetic unit illustrated in FIG. 1.

FIG. 11 is a diagram schematically illustrating a configuration example of a harmonic current detection unit of a rotation speed estimation unit illustrated in FIG. 10.

FIG. 12 is a diagram for describing an example of the operation of a band pass filter.

FIG. 13 is a diagram for describing an example of the operation of an FFT analysis unit.

FIG. 14 is a diagram for describing an example of the operation of the FFT analysis unit.

FIG. 15 is a diagram schematically illustrating a configuration example of a parameter arithmetic unit illustrated in FIG. 1.

FIG. 16 is a flowchart illustrating an example of the operation of the inverter control apparatus and the synchronous machine driving apparatus according to the first embodiment.

FIG. 17 is a flowchart illustrating an example of a parameter tuning operation in the inverter control apparatus and the synchronous machine driving apparatus according to the first embodiment.

FIG. 18 is a diagram for describing an example of table data generated by the parameter arithmetic unit illustrated in FIG. 15.

FIG. 19 is a diagram for describing the first modification of the table data generated by the parameter arithmetic unit illustrated in FIG. 15.

FIG. 20 is a diagram for describing the second modification of the table data generated by the parameter arithmetic unit illustrated in FIG. 15.

FIG. 21 is a block diagram schematically illustrating a configuration example of an inverter control apparatus and a synchronous machine driving apparatus according to the second embodiment.

FIG. 22 is a diagram schematically illustrating an example of flags generated by the flag generation unit illustrated in FIG. 21.

FIG. 23 is a block diagram schematically illustrating a configuration example of a rotation determination unit of the flag generation unit illustrated in FIG. 21.

FIG. 24 is a block diagram schematically illustrating a configuration example of the voltage command generation unit illustrated in FIG. 21.

FIG. 25 is a block diagram schematically illustrating a configuration example of the rotation angle/speed arithmetic unit illustrated in FIG. 21.

FIG. 26 is a flowchart illustrating an example of the operation of the inverter control apparatus and the synchronous machine driving apparatus according to the second embodiment.

FIG. 27 is a diagram schematically illustrating a configuration of a resistance calculation unit of the parameter arithmetic unit illustrated in FIG. 21.

FIG. 28 is a flowchart illustrating an example of the operation of the inverter control apparatus and the synchronous machine driving apparatus according to the modification of the second embodiment.

FIG. 29 is a diagram illustrating an example of timing at which the parameter arithmetic unit of the inverter control apparatus according to the modification of the second embodiment latches the motor winding resistance value.

FIG. 30 is a block diagram schematically illustrating a configuration example of an inverter control apparatus and a synchronous machine driving apparatus according to the third embodiment.

FIG. 31 is a block diagram schematically illustrating a configuration example of a voltage command generation unit illustrated in FIG. 30.

FIG. 32 is a block diagram schematically illustrating a configuration example of a parameter arithmetic unit illustrated in FIG. 30.

FIG. 33 is a diagram schematically illustrating an example of flags generated by a flag generation unit illustrated in FIG. 30.

FIG. 34 is a flowchart illustrating an example of the operation of the inverter control apparatus and the synchronous machine driving apparatus according to the third embodiment.

### DETAILED DESCRIPTION

An inverter control apparatus according to an embodiment includes a voltage command generation unit that generates a voltage command to be applied to a synchronous machine, a current detection unit that detects a current flowing from an inverter main circuit driven by a gate command based on the voltage command to the synchronous machine, a flag generation unit that switches between a motor parameter tuning operation and a normal driving operation, a parameter arithmetic unit that calculates a motor parameter using a value of the voltage command and a detection value of the current detection unit at a time of a motor parameter tuning operation, wherein the voltage command generation unit generates the voltage command to apply a DC voltage to the synchronous machine at a time of motor parameter tuning operation.

Hereinafter, an inverter control apparatus and a synchronous machine driving apparatus according to embodiments will be described with reference to the drawings.

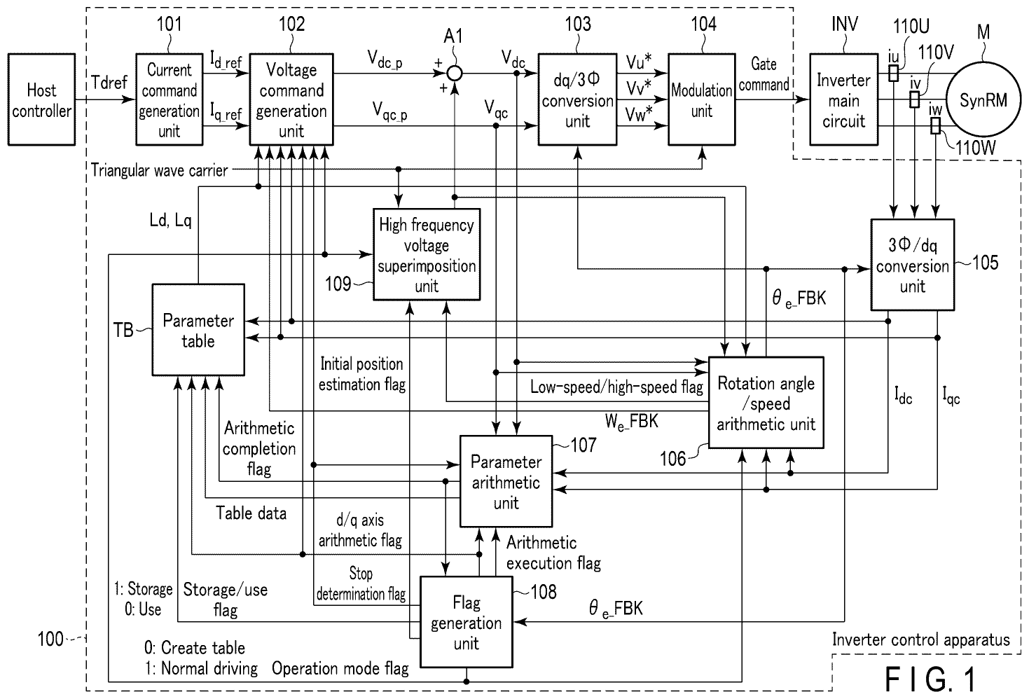

FIG. 1 is a diagram schematically illustrating a configuration example of an inverter control apparatus and a synchronous machine driving apparatus according to the first embodiment.

The synchronous machine driving apparatus according to the first embodiment includes an inverter main circuit INV and an inverter control apparatus 100.

The inverter main circuit INV converts DC power into three-phase AC power to output the three-phase AC power to a synchronous machine M. The inverter main circuit INV includes an upper-arm switching element and a lower-arm switching element in each phase.

A control signal (gate command) of the switching elements of the upper arm and the lower arm is supplied from the inverter control apparatus 100 to the inverter main circuit INV. The inverter main circuit INV can mutually convert AC power and DC power by switching on/off of the switching element.

The synchronous machine M is, for example, a motor having magnetic saliency such as a permanent magnet synchronous motor (PMSM) or a synchronous reluctance motor (SynRM). In the present embodiment, an example in which the SynRM is used as the synchronous machine M will be described.

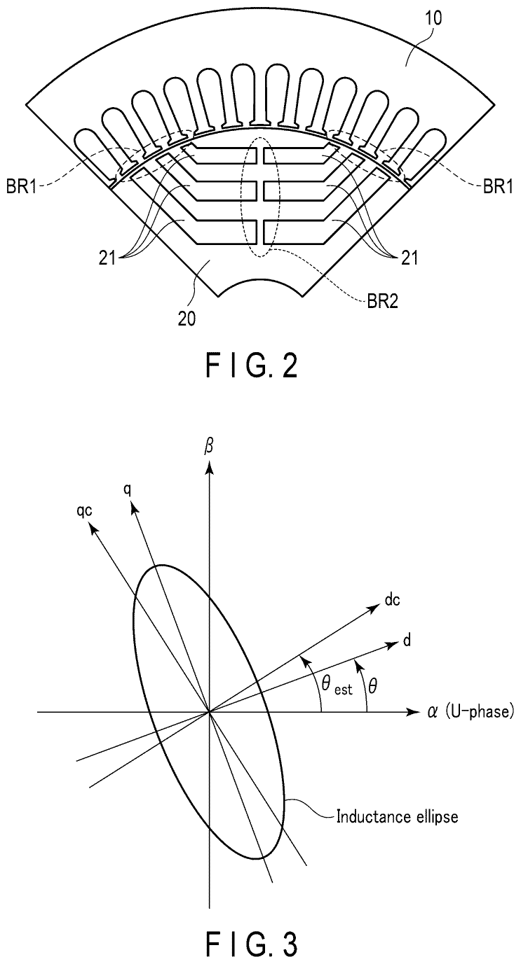

FIG. 2 is a diagram schematically illustrating an example of a synchronous machine driven by the synchronous machine driving apparatus according to an embodiment.

Here, the configuration of the SynRM is illustrated as an example of the synchronous machine M. The synchronous machine M includes a rotor 20 and a stator 10, a magnetic field is generated by a three-phase AC current flowing through each excitation phase, and a torque is generated by magnetic interaction with the rotor 20. Here, only part of the synchronous machine M is illustrated, and the stator 10 and the rotor 20 of the synchronous machine M are, for example, a combination of a plurality of configurations illustrated in FIG. 2.

The rotor 20 includes an air gap 21, an outer peripheral bridge BR1, and a center bridge BR2.

The center bridge BR2 is disposed on a line connecting the outer periphery and the center of the rotor 20. The line in which the center bridges BR2 are disposed is the d axis. The outer peripheral bridge BR1 is located between the outer periphery of the rotor 20 and the air gap 21. In a portion of the synchronous machine M illustrated in FIG. 2, six air gaps 21 extending between an outer peripheral portion and a central portion of the rotor 20 are provided. The air gap 21 extends between the center bridge BR2 and the outer peripheral bridge BR1 in line symmetry with respect to the d axis.

FIG. 3 is a diagram for describing a definition of a rotation coordinate system (d axis, q axis) and an estimation rotation coordinate system (dc axis, qc axis) in an embodiment.

In the present embodiment, the d axis is an axis in which the magnetic saliency decreases, and the q axis is an axis in which the magnetic saliency increases. The dc axis is the d axis in the estimation rotation coordinate system, and the qc axis is the q axis in the estimation rotation coordinate system.

The d axis is a vector axis rotated by a rotation phase angle θ from the α axis (U-phase) of an αβ fixed coordinate system, and the q axis is a vector axis orthogonal to the d axis at an electrical angle. On the other hand, the dcqc estimation rotation coordinate system corresponds to the d axis and the q axis at the estimated position of the rotor 20. That is, the dc axis is a vector axis rotated from the α axis by the rotation phase angle estimation value θest (corresponding to θₑ_FBK in FIG. 1), and the qc axis is a vector axis orthogonal to the dc axis at an electrical angle. In other words, the vector axis rotated by the estimation error Δθ from the d axis is the dc axis, and the vector axis rotated by the estimation error Δθ from the q axis is the qc axis.

The inverter control apparatus 100 includes an arithmetic apparatus including at least one processor such as a CPU or an MPU, and a memory in which a program executed by the processor is recorded. The inverter control apparatus 100 can realize various functions described below by software or by a combination of software and hardware.

The inverter control apparatus 100 acquires the torque command T_{dref} from the host controller. The host controller performs control so that a plurality of configurations operates in cooperation in a device equipped with the synchronous machine M and the inverter main circuit INV. The host controller may include a user interface such as an operation panel, for example, and may output the torque command T_{dref} based on the operation of the user interface to the inverter control apparatus 100.

The inverter control apparatus 100 includes a current command generation unit 101, a voltage command generation unit 102, a coordinate (dq/3Φ) conversion unit 103, a modulation unit 104, a coordinate (3Φ/dq) conversion unit 105, a rotation angle/speed arithmetic unit 106, a parameter arithmetic unit 107, a flag generation unit 108, a high frequency voltage superimposition unit 109, current detectors (current detection units) 110U, 110V, and 110W, a parameter table TB, and an adder A1.

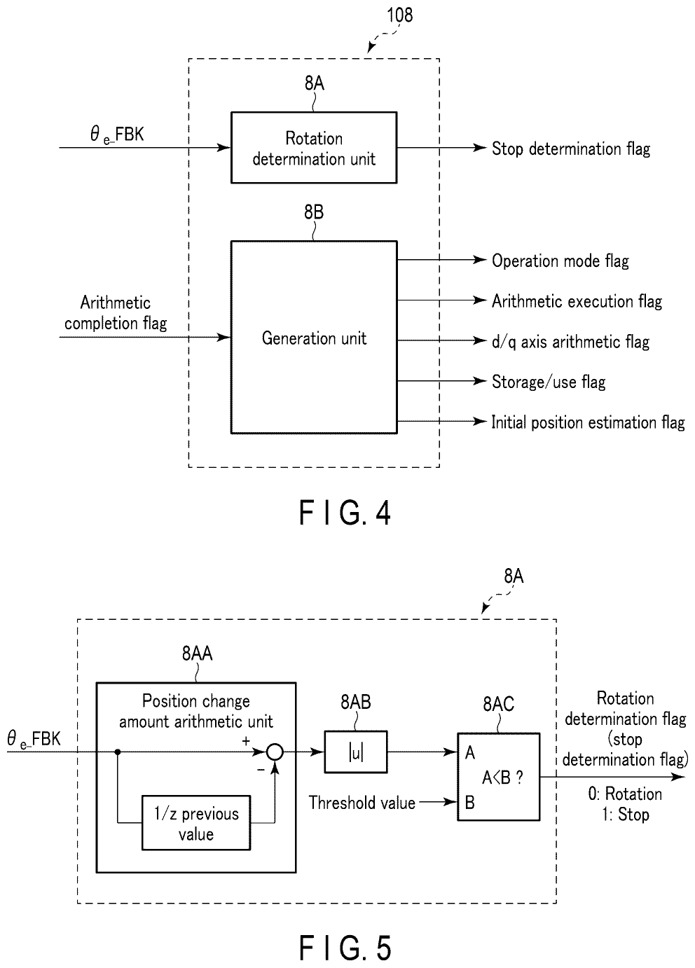

FIG. 4 is a diagram schematically illustrating a configuration example of a flag generation unit illustrated in FIG. 1.

The flag generation unit 108 includes a rotation determination unit 8A and a generation unit 8B.

The rotation determination unit 8A generates a stop determination flag for determining stop of the electric motor. The rotation determination unit 8A determines whether the synchronous machine M is rotating or stopped (stop state of the synchronous machine M) using the estimated value θₑ_FBK of the rotation phase angle calculated based on the detection value of the three-phase AC currents (iu, iv, iw). The rotation determination unit 8A sets the stop determination flag to 1 in a case where the synchronous machine M is stopped, and sets the stop determination flag to zero in a case where the synchronous machine M is rotating.

FIG. 5 is a diagram schematically illustrating a configuration example of a rotation determination unit illustrated in FIG. 4.

The rotation determination unit 8A includes a position change amount arithmetic unit 8AA, an absolute value arithmetic unit 8AB, and a comparison unit 8AC.

The position change amount arithmetic unit 8AA acquires the estimated value θₑ_FBK of the rotation phase angle of the synchronous machine M, and calculates and outputs the difference between the current value and the previous value of the estimated value θₑ_FBK.

The absolute value arithmetic unit 8AB calculates and outputs an absolute value of the output value of the position change amount arithmetic unit 8AA.

The comparison unit 8AC compares the output value (A) of the absolute value arithmetic unit 8AB with the threshold value (B), outputs the stop determination flag as 1 (stop) when A<B, and outputs the stop determination flag as zero (rotation) when A≥B.

When the arithmetic completion flag is zero (arithmetic is not completed) (when the synchronous machine M stops and the DC current applied to the synchronous machine M is less than the threshold value), the generation unit 8B generates a plurality of flags used for control at the time of the motor parameter tuning operation. In the present embodiment, the generation unit 8B generates an operation mode flag, an arithmetic execution flag, a d/q axis arithmetic flag, a storage/use flag, and an initial position estimation flag.

The operation mode flag is supplied to the voltage command generation unit 102, the high frequency voltage superimposition unit 109, and the rotation angle/speed arithmetic unit 106, and is used to switch between a parameter tuning (motor parameter arithmetic) operation and a normal driving operation.

The arithmetic execution flag is supplied to the parameter arithmetic unit 107 and used to manage the motor parameter arithmetic execution.

The d/q axis arithmetic flag is supplied to the parameter arithmetic unit 107 and the parameter table TB, and is used to control whether to calculate a parameter related to either the d axis or the q axis.

The storage/use flag is supplied to the parameter table TB and used to switch between data storage and use of the created parameter table TB.

The initial position estimation flag is supplied to the high frequency voltage superimposition unit 109 and used to determine a period for estimating the stop position of the rotor 20 of the synchronous machine M.

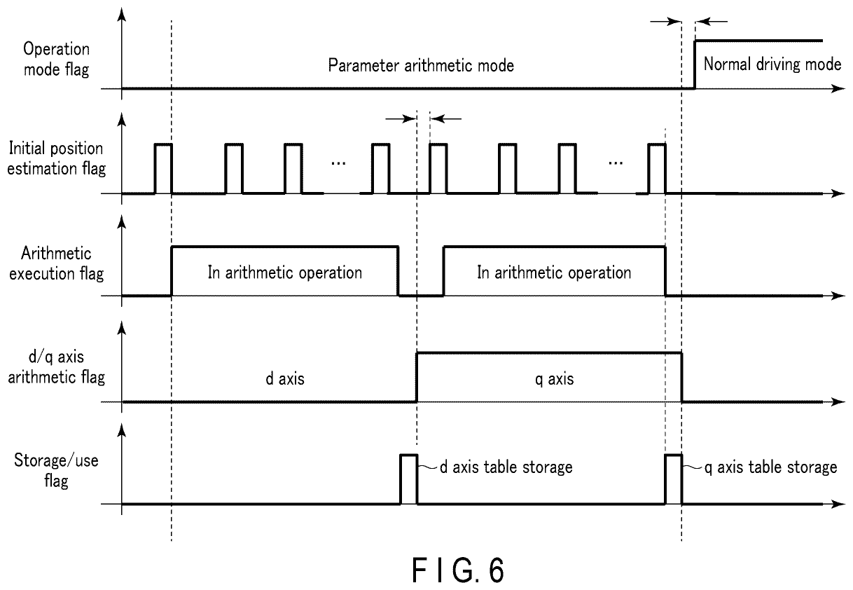

FIG. 6 is a diagram schematically illustrating an example of a flag generated by the generation unit.

When the synchronous machine M is stopped and the DC current applied to the synchronous machine M is less than the threshold value (when the arithmetic completion flag is zero), the generation unit 8B sets the operation mode flag to zero (motor parameter tuning operation) and sets the inverter control apparatus 100 to the parameter arithmetic mode. In response to the arithmetic completion flag being set to 1, the generation unit 8B sets the operation mode flag to 1 (normal driving operation) and sets the inverter control apparatus 100 to the normal driving mode.

The generation unit 8B generates an initial position estimation flag that cyclically rises (from zero to 1) in a period in which the operation mode flag is zero (motor parameter tuning operation).

The generation unit 8B raises the arithmetic execution flag at the timing when the initial position estimation flag first changes from 1 to zero. The generation unit 8B sets the arithmetic execution flag to 1 and then sets the arithmetic execution flag to zero after a predetermined time elapses, and thereafter sets the arithmetic execution flag at a timing when the initial position estimation flag first changes from 1 to zero.

The generation unit 8B raises the storage/use flag in response to the arithmetic execution flag changing from 1 to zero. The generation unit 8B switches the value of the d/q axis arithmetic flag at timing when the storage/use flag is changed from 1 to zero.

The current command generation unit 101 generates a d axis current command I_{d_ref} and a q axis current command I_{q_ref} based on the torque command T_{dref}. For example, the current command generation unit 101 converts the torque command T_{dref} into the current amplitude command I_{dq}* by Expression (2) calculated from the following Expression (1), and calculates the d axis current command I_{d_ref} and the q axis current command I_{q_ref} from the current amplitude command I_{dq}* and the current phase command β* as in the following Expressions (3) to (4).

$$\begin{matrix}{T}_{rq} *= {P}_{p} ( {L}_{d} - {L}_{q} ) {I}_{d} {I}_{q} = {P}_{p} ( {L}_{d} - {L}_{q} ) ( - {I}_{dq} sin β ) ( {I}_{dq} cos β ) \\ = - \frac{{P}_{p}}{2} ( {L}_{d} - {L}_{q} ) {I}_{dq} {*}^{2} sin 2 β *\end{matrix} \qquad ( 1 )$$

$${I}_{dq} *= \sqrt{\frac{{T}_{rq} *}{\frac{{P}_{p}}{2} ( {L}_{q} - {L}_{d} ) sin 2 β}} \qquad ( 2 )$$

$${I}_{d\_ref} = - {I}_{dq} * sin β * \qquad ( 3 )$$

$${I}_{q\_ref} = - {I}_{dq} * cos β * \qquad ( 4 )$$

where Pp is a pole logarithm of the synchronous machine, L_{d} is a d axis inductance with respect to the fundamental wave current, L_{q} is a q axis inductance with respect to the fundamental wave current, and β* is a current phase command.

The voltage command generation unit 102 includes a parameter calculation function unit 2A and a normal driving function unit 2B, and switches a function (mode) that operates according to the value of the operation mode flag and the value of the stop determination flag.

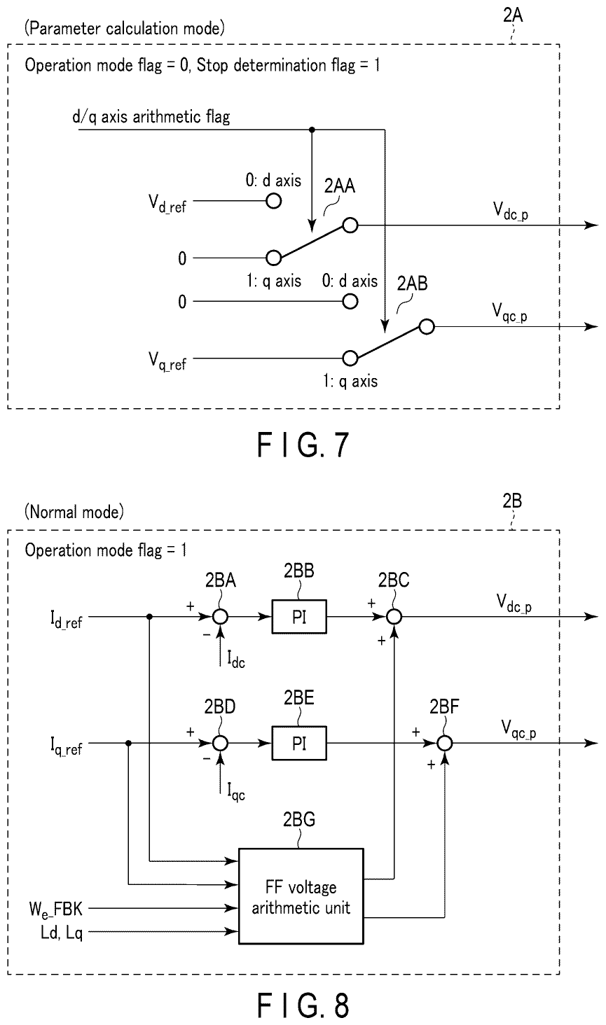

FIG. 7 is a block diagram schematically illustrating a configuration example of a parameter calculation function unit of the voltage command generation unit.

When the operation mode flag is zero and the stop determination flag is 1, the parameter calculation function unit 2A of the voltage command generation unit 102 sets a d axis voltage command V_{dc_p} and a q axis voltage command V_{qc_p} at the time of motor parameter arithmetic. The parameter calculation function unit 2A includes output switching units 2AA and 2AB.

The output switching unit 2AA switches any of the input values of the d axis voltage command V_{d_ref} and zero as the output value (the d axis voltage command V_{dc_p}) according to the value of the d/q axis arithmetic flag. The output switching unit 2AA sets the output value to the value of the d axis voltage command V_{d_ref} when the d/q axis arithmetic flag is zero, and sets the output value to zero when the d/q axis arithmetic flag is 1.

The output switching unit 2AB switches any of the input values of the q axis voltage command V_{q_ref} and zero as the output value (q axis voltage command V_{qc_p}) according to the value of the d/q axis arithmetic flag. The output switching unit 2AB sets the output value to zero when the d/q axis arithmetic flag is zero, and sets the output value to the value of the q axis voltage command V_{q_ref} when the d/q axis arithmetic flag is 1.

The maximum values of the voltage commands V_{d_ref} and V_{q_ref} used by the parameter calculation function unit 2A are determined using the values of the rated current and the motor winding resistance R of the synchronous machine M. That is, since a quotient obtained by dividing the values of the voltage commands V_{d_ref} and V_{q_ref} by the value of the motor winding resistance R is the current value flowing through the synchronous machine M, the maximum value of the voltage applied to the synchronous machine M can be determined so that the current exceeding the rated current does not flow.

The voltage command calculated by the parameter calculation function unit 2A may be generated so that a predetermined switching element is kept turned on in a switching pattern for applying a voltage of a predetermined conduction phase (d axis or q axis). In this case, in a case where the DC voltage applied to the inverter main circuit INV is high, the current may immediately increase to cause a failure of the element or the like. In order to avoid this, it is desirable to control the average value of the voltage by PWM modulating the voltage command and applying the voltage command to the inverter INV.

FIG. 8 is a block diagram schematically illustrating a configuration example of a normal driving function unit of the voltage command generation unit.

When the operation mode flag is 1, the normal driving function unit 2B of the voltage command generation unit 102 performs PI control based on the current deviation to set a voltage command value for matching the current command with the current detection value. The normal driving function unit 2B includes subtraction units 2BA and 2BD, PI control units 2BB and 2BE, addition units 2BC and 2BF, and an FF voltage arithmetic unit 2BG.

The FF voltage arithmetic unit 2BG acquires values of the d axis current command I_{d_ref}, the q axis current command I_{q_ref}, the angular velocity, the d axis inductance L_{d} for the fundamental wave current, and the q axis inductance L_{q} for the fundamental wave current, and calculates feedforward voltage commands V_{d_FF} (=ωₑ_FBK×I_{q_ref}×L_{q}) and V_{q_FF} (=ωₑ_FBK×I_{d_ref}×L_{d}) as in Expression (11) described later.

The subtraction unit 2BA calculates and outputs a difference (I_{d_ref}−I_{dc}) between the d axis current command I_{d_ref} and the d axis current I_{d} in the estimation rotation coordinate system.

The PI control unit 2BB acquires the output value of the subtraction unit 2BA, performs PI control so that the difference between the d axis current command I_{d_ref} and the d axis current I_{dc} in the estimation rotation coordinate system follows zero, and calculates the d axis voltage command V_{dc}.

The addition unit 2BC acquires the value of the d axis voltage command V_{dc} calculated by the PI control unit 2BB and the value of the d axis feedforward voltage command V_{d_FF}, calculates a sum obtained by adding the acquired values, and outputs the sum.

The subtraction unit 2BD calculates and outputs a difference (I_{q_ref}−I_{qc}) between the q axis current command I_{q_ref} and the q axis current I_{dc} in the estimation rotation coordinate system.

The PI control unit 2BE acquires the output value of the subtraction unit 2BD, performs PI control so that the difference between the q axis current command I_{q_ref} and the q axis current I_{qc} in the estimation rotation coordinate system follows zero, and calculates the q axis voltage command V_{qc}.

The addition unit 2BF acquires the value of the q axis voltage command V_{qc} calculated by the PI control unit 2BE and the value of the q axis feedforward voltage command V_{q_FF}, calculates a sum obtained by adding the acquired values, and outputs the sum.

The voltage command generation unit 102 outputs the output value of the addition unit 2BC as a d axis voltage command V_{dc_p}, and outputs the output value of the addition unit 2BF as a q axis voltage command V_{qc_p}.

In the voltage command generation unit 102, when the operation mode flag is zero and the stop determination flag is 1, the parameter calculation function unit 2A operates, when the operation mode flag is 1, the normal driving function unit 2B operates, and when the operation mode flag is zero and the stop determination flag is zero (until the motor stops after the parameter tuning is started), the parameter calculation function unit 2A and the normal driving function unit 2B of the voltage command generation unit 102 are stopped.

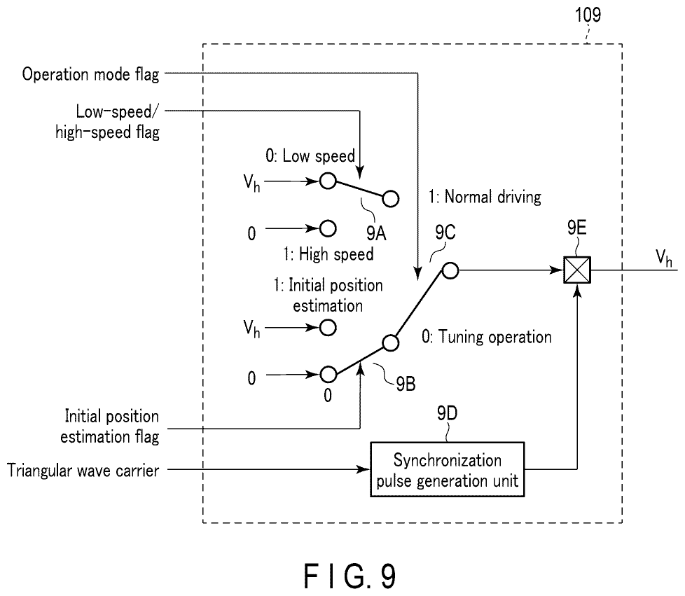

FIG. 9 is a diagram schematically illustrating a configuration example of a high frequency voltage superimposition unit illustrated in FIG. 1.

The high frequency voltage superimposition unit 109 generates a high frequency voltage of an any frequency corresponding to the triangular wave carrier (carrier command) for the d axis or the q axis or both the d axis and the q axis according to the values of the operation mode flag, the low-speed/high-speed flag, and the initial position estimation flag to output the generated high frequency voltage to the adder A1. In the present embodiment, the high frequency voltage superimposition unit 109 outputs the d axis high frequency voltage Vₕ.

The high frequency voltage superimposition unit 109 includes switches 9A, 9B, and 9C, a synchronization pulse generation unit 9D, and a high frequency voltage synchronization unit (logical product arithmetic unit) 9E.

The switch 9A acquires the value of the internally generated voltage command Vₕ having a predetermined magnitude, and switches the output value according to the value of the low-speed/high-speed flag. The switch 9A outputs the value of the voltage command Vₕ when the low-speed/high-speed flag is zero (low speed), and outputs zero when the low-speed/high-speed flag is 1 (high speed).

The switch 9B acquires the value of the internally generated voltage command Vₕ having a predetermined magnitude, and switches the output value according to the value of the initial position estimation flag. The switch 9B outputs the value of the voltage command Vₕ when the initial position estimation flag is 1, and outputs zero when the initial position estimation flag is zero.

The switch 9C acquires the output value of the switch 9A and the output value of the switch 9B, and switches the output value according to the value of the operation mode flag. The switch 9C outputs the output value of the switch 9A when the operation mode flag is 1 (normal driving operation), and outputs the output value of the switch 9B when the operation mode flag is zero (motor parameter tuning operation).

The synchronization pulse generation unit 9D generates a synchronization pulse synchronized with the triangular wave carrier to output the synchronization pulse to the high frequency voltage synchronization unit 9E. The high frequency voltage synchronization unit 9E multiplies the output value of the switch 9C by the synchronization pulse to output the resultant.

The high frequency voltage superimposition unit 109 outputs the output value of the high frequency voltage synchronization unit 9E to the adder A1. That is, when the operation mode flag is 1 and the low-speed/high-speed flag is zero, and when the operation mode flag is zero and the initial position estimation flag is 1, the output value of the high frequency voltage superimposition unit 109 outputs the high frequency voltage command Vₕ having the predetermined amplitude Vₕ and the high frequency voltage cycle (1/fₕ) synchronized with the cycle of the triangular wave carrier. The high frequency voltage superimposition unit 109 outputs zero when the operation mode flag is 1 and the low-speed/high-speed flag is 1, and when the operation mode flag is zero and the initial position estimation flag is zero.

The high frequency voltage command value Vₕ output from the high frequency voltage superimposition unit 109 is added to the d axis voltage command V_{dc_p} by the adder A1, and the output value of the adder A1 is supplied to the coordinate (dq/3Φ) conversion unit 103 as the d axis voltage command value V_{dc}. In the present embodiment, the high frequency voltage command value Vₕ is not added to the q axis voltage command V_{qc_p}, and the q axis voltage command V_{qc_p} generated by the voltage command generation unit 102 is supplied to the coordinate (dq/3Φ) conversion unit 103 and the parameter arithmetic unit 107 as the q axis voltage command V_{qc}.

The coordinate (dq/3Φ) conversion unit 103 converts the supplied voltage command values V_{dc_p} and V_{qc_p} into vector values Vu*, Vv*, and Vw* of the three-phase fixed coordinate system using the estimated value of the rotation angle to output the vector values to the modulation unit 104.

The modulation unit 104 converts the three-phase voltage command values Vu*, Vv*, and Vw* into gate commands of the inverter main circuit INV. In the present embodiment, the modulation unit 104 generates a gate command by PWM modulation for comparing the triangular wave carrier with the voltage command values Vu*, Vv*, and Vw* to output the gate command to the inverter main circuit INV.

The current detectors 110U, 110V, and 110W detect two-phase or three-phase AC currents (iu, iv, iw) among three-phase AC currents flowing through the synchronous machine. In a case where the two-phase AC current in the three phases is detected, the value of the AC current of the remaining one phase can be calculated using the detection value of the two-phase AC current.

The coordinate (3Φ/dq) conversion unit 105 converts the detection values of the current detectors 110U, 110V, and 110W from the values of the three-phase fixed coordinate system into the values of the d axis current I_{dc} and the q axis current I_{qc} in the estimation rotation coordinate system using the estimated value θₑ_FBK of the rotation angle.

The rotation angle/speed arithmetic unit 106 outputs the rotation angle θₑ_FBK and the rotation angular velocity ωₑ_FBK according to the value of the operation mode flag. In addition, the rotation angle/speed arithmetic unit 106 generates and outputs a value of the low-speed/high-speed flag according to the rotation speed of the synchronous machine M during the normal driving.

In a case where the operation mode flag is zero (motor parameter tuning operation), the rotation angle/speed arithmetic unit 106 fixes the angular velocity ωₑ_FBK to zero and also fixes the angle θₑ_FBK in order to calculate the motor parameter by applying the DC voltage to the synchronous machine M. In this case, the fixed angle θₑ_FBK is, for example, a value of the initial position estimation result. By setting the angular velocity ωₑ_FBK and the angle θₑ_FBK as described above at the time of motor parameter tuning, it is possible to apply the DC voltage after grasping the position of the rotor 20 of the synchronous machine M.

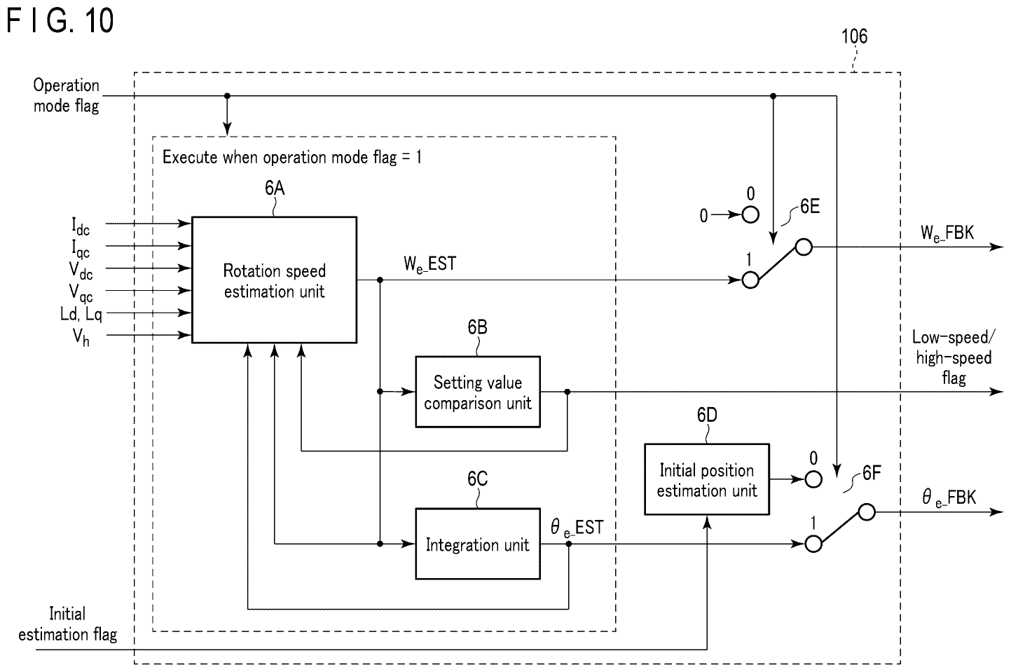

FIG. 10 is a diagram schematically illustrating a configuration example of a rotation angle/speed arithmetic unit illustrated in FIG. 1.

The rotation angle/speed arithmetic unit 106 includes a rotation speed estimation unit 6A, a setting value comparison unit 6B, an integration unit 6C, an initial position estimation unit 6D, and switches 6E and 6F.

The rotation speed estimation unit 6A operates when the operation mode flag is 1 (normal driving operation), acquires the inductances L_{d} and L_{q} corresponding to the current values I_{dc} and I_{dc} from the table TB, and calculates the estimated value ωₑ_EST of the rotation angular velocity using, for example, the values of the inductances L_{d} and L_{q}, the d axis current I_{dc}, the q axis current I_{dc}, the voltage commands V_{dc} and V_{qc}, the high frequency voltage command Vₕ, and the like.

In a case where the operation mode flag is 1, the rotation speed estimation unit 6A calculates the angular velocity estimated value ωₑ_EST, and integrates the angular velocity estimated value ωₑ_EST to calculate the angle estimated value θₑ_EST. The rotation speed estimation unit 6A can use, for example, a method of observing a high frequency current in the low-speed rotation range of the synchronous machine M and a method of observing an induced voltage in the high-speed rotation range of the synchronous machine M according to the value of the low-speed/high-speed flag.

For example, in the SynRM, a voltage equation in a case where the rotation phase angle error Dq is zero (in a case where the actual dq axis matches the estimated dcqc axis) is expressed by the following Expression (5).

$$[ \begin{matrix}{v}_{d} \\ {v}_{q}\end{matrix} ] = [ \begin{matrix}R + {pL}_{d} & - {ω}_{e} {L}_{q} \\ {ω}_{e} {L}_{d} & R + {pL}_{q}\end{matrix} ] [ \begin{matrix}{i}_{d} \\ {i}_{q}\end{matrix} ] \qquad ( 5 )$$

In Expression (5), v_{d} is a d axis voltage, v_{q} is a q axis voltage, i_{d} is a d axis current, i_{q} is a q axis current, R is an armature winding resistance (motor winding resistance), ωₑ is an electrical angle angular velocity, L_{d} is a d axis inductance, L_{q} is a q axis inductance, and p is a differential operator (=d/dt).

In contrast to the voltage equation (5) in a case where the estimation rotation phase angle θₑ_EST matches the true rotation phase angle θₑ, the dq axis voltage equation is rewritten as the following Expression (6) using the rotation angle error Δθ in a case where the estimation rotation phase angle does not match the true rotation phase angle.

$$[ \begin{matrix}{v}_{d c} \\ {v}_{qc}\end{matrix} ] = [ \begin{matrix}R - {ω}_{e} {L}_{dqc} & - {ω}_{e} {L}_{qc} \\ {ω}_{e} {L}_{d c} & R + {ω}_{e} {L}_{dqc}\end{matrix} ] [ \begin{matrix}{i}_{d c} \\ {i}_{qc}\end{matrix} ] + p [ \begin{matrix}{L}_{d c} & {L}_{dqc} \\ {L}_{dqc} & {L}_{qc}\end{matrix} ] [ \begin{matrix}{i}_{d c} \\ {i}_{qc}\end{matrix} ] \qquad ( 6 )$$

$$where$$

$$\begin{matrix}\begin{matrix}{L}_{0} = \frac{( {L}_{d} + {L}_{q} )}{2} & {L}_{1} = \frac{( {L}_{d} - {L}_{q} )}{2}\end{matrix} \\ {L}_{d c} = {L}_{0} + {L}_{1} cos 2 Δθ = \frac{( {L}_{d} + {L}_{q} )}{2} + \frac{( {L}_{d} - {L}_{q} )}{2} cos 2 Δθ \\ {L}_{qc} = {L}_{0} - {L}_{1} cos 2 Δθ = \frac{( {L}_{d} + {L}_{q} )}{2} - \frac{( {L}_{d} - {L}_{q} )}{2} cos 2 Δθ \\ {L}_{dqc} = {L}_{1} sin 2 Δ θ = \frac{1}{2} ( {L}_{d} - {L}_{q} ) sin 2 Δθ\end{matrix}$$

In a case where the low-speed/high-speed flag is zero (low speed), the rotation speed estimation unit 6A can observe the high frequency current supplied to the synchronous machine M and calculate the estimated value of the rotation angular velocity as follows. For example, a high frequency current is generated in the output current of the inverter main circuit INV according to the high frequency voltage command Vₕ superimposed on the voltage command. The rotation angle/speed arithmetic unit 106 can calculate an estimated value of the rotation angular velocity corresponding to the rotor position and the initial position of the synchronous machine M in the low-speed range using the detected amplitude of the high frequency current and the high frequency voltage command Vₕ. Note that the value of the high frequency voltage command Vₕ generated by the high frequency voltage superimposition unit 109 may be set in advance in the rotation angle/speed arithmetic unit 106, and the rotation angle/speed arithmetic unit 106 may acquire the high frequency voltage command Vₕ output from the high frequency voltage superimposition unit 109.

When Expression (6) is summarized for the current derivative term, Expression (7) is obtained.

$$p [ \begin{matrix}{i}_{d c} \\ {i}_{qc}\end{matrix} ] = \frac{1}{{L}_{d} {L}_{q}} [ \begin{matrix}{L}_{0} - {L}_{1} cos 2 Δθ & - {L}_{1} sin 2 Δθ \\ - {L}_{1} sin 2 Δθ & {L}_{0} + {L}_{1} cos 2 Δθ\end{matrix} ] \{ [ \begin{matrix}{v}_{d c} \\ {v}_{qc}\end{matrix} ] - [ \begin{matrix}R & - {ω}_{e} {L}_{0} \\ {ω}_{e} {L}_{0} & R\end{matrix} ] [ \begin{matrix}{i}_{d} \\ {i}_{q}\end{matrix} ] - [ \begin{matrix}- {ω}_{e} {L}_{1} sin 2 Δθ & {ω}_{e} {L}_{1} cos 2 Δθ \\ {ω}_{e} {L}_{1} cos 2 Δθ & {ω}_{e} {L}_{1} sin 2 Δθ\end{matrix} ] [ \begin{matrix}{i}_{d c} \\ {i}_{qc}\end{matrix} ] \} \qquad ( 7 )$$

At this time, in a case where the rotation speed of the synchronous machine M is sufficiently low and the voltage drop due to the motor winding resistance can be ignored, the above Expression (7) is rewritten as Expression (8).

$$p [ \begin{matrix}{i}_{d c} \\ {i}_{qc}\end{matrix} ] = \frac{1}{{L}_{d} {L}_{q}} [ \begin{matrix}{L}_{0} - {L}_{1} cos 2 Δθ & - {L}_{1} sin 2 Δθ \\ - {L}_{1} sin 2 Δθ & {L}_{0} + {L}_{1} cos 2 Δθ\end{matrix} ] [ \begin{matrix}{v}_{d c} \\ {v}_{qc}\end{matrix} ] \qquad ( 8 )$$

Furthermore, when the high frequency voltage command Vₕ is applied only to the dc axis which is the estimation axis of the d axis, the high frequency voltage command v_{qh} of the q axis is zero and it is an equation for the high frequency voltage command v_{dh} of the d axis, and the above Expression (8) is rewritten as Expression (9).

$$p [ \begin{matrix}{i}_{d c} \\ {i}_{qc}\end{matrix} ] = \frac{1}{{L}_{d} {L}_{q}} [ \begin{matrix}{L}_{q} \\ \frac{- {L}_{d} + {L}_{q}}{2} \cdot 2 Δθ\end{matrix} ] {v}_{dh} = [ \begin{matrix}\frac{1}{{L}_{d}} \\ \frac{{L}_{q} - {L}_{d}}{{L}_{d} {L}_{q}} Δθ\end{matrix} ] {v}_{dh} \qquad ( 9 )$$

According to the above Expression (9), it can be seen that the harmonic current of the qc axis changes depending on the rotation angle error Δθ. Therefore, focusing on the qc axis component of the harmonic current, the rotation phase angle error Δθ is expressed by the following Expression (10).

$$Δθ = \frac{{L}_{d} {L}_{q}}{{L}_{q} - {L}_{d}} \frac{{pi}_{qc}}{{v}_{dh}} \qquad ( 10 )$$

As described above, the rotation speed estimation unit 6A can calculate the estimated value ωₑ_EST of the rotation speed by calculating the rotation phase angle error Δθ by Expression (10) using the characteristic that the qc axis component of the harmonic current depends on the rotational movement angle error Δθ and performing phase locked loop (PLL) control so that the rotation phase angle error Δθ converges to zero.

In addition, the rotation speed estimation unit 6A may calculate the estimated value ωₑ_EST of the rotation speed by observing both the dc axis component and the qc axis component of the harmonic current. For example, when the qc axis current i_{qc} in Expression (9) is divided by the dc axis current i_{dc}, and the amplitudes of the high frequency currents are I_{dch} and I_{qch}, the rotation phase angle error Δθ is expressed by the following Expression (10)′.

$$\begin{matrix}\frac{{pi}_{qc}}{{pi}_{d c}} = \frac{\frac{{L}_{q} - {L}_{d}}{{L}_{d} {L}_{q}} Δθ}{\frac{1}{{L}_{d}}} \frac{{v}_{dh}}{{v}_{dh}} - \frac{{L}_{q} - {L}_{d}}{{L}_{q}} Δθ \\ Δθ = \frac{{L}_{q}}{{L}_{q} - {L}_{d}} \frac{{pi}_{qc}}{{pi}_{d c}} \\ Δθ = \frac{{L}_{q}}{{L}_{q} - {L}_{d}} \frac{{I}_{qch}}{{I}_{dch}}\end{matrix} \qquad {( 10 )}^{′}$$

In this case, the rotation speed estimation unit 6A may include a harmonic current detection unit that extracts the amplitude of the harmonic current. The rotation speed estimation unit 6A can calculate the estimated value ωₑ_EST of the rotation speed by calculating the rotation phase angle error Δθ by Expression (10)′ and performing PLL control so that the rotation phase angle error Δθ converges to zero.

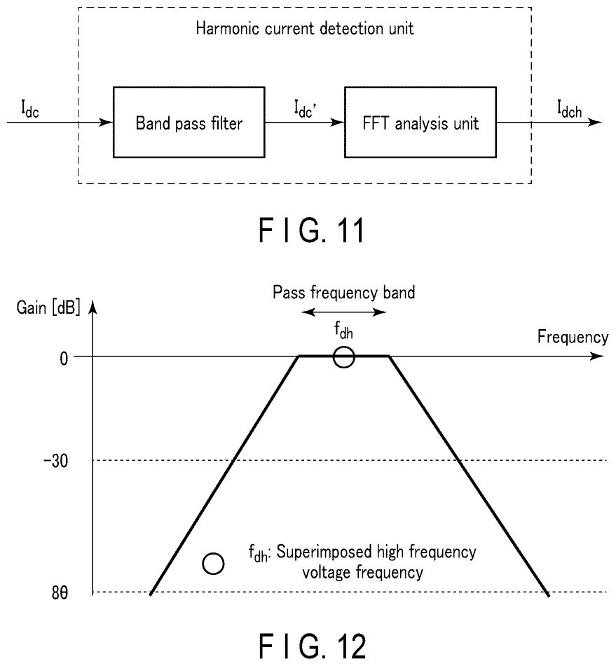

FIG. 11 is a diagram schematically illustrating a configuration example of a harmonic current detection unit of a rotation speed estimation unit illustrated in FIG. 10.

FIG. 12 is a diagram for describing an example of the operation of a band pass filter.

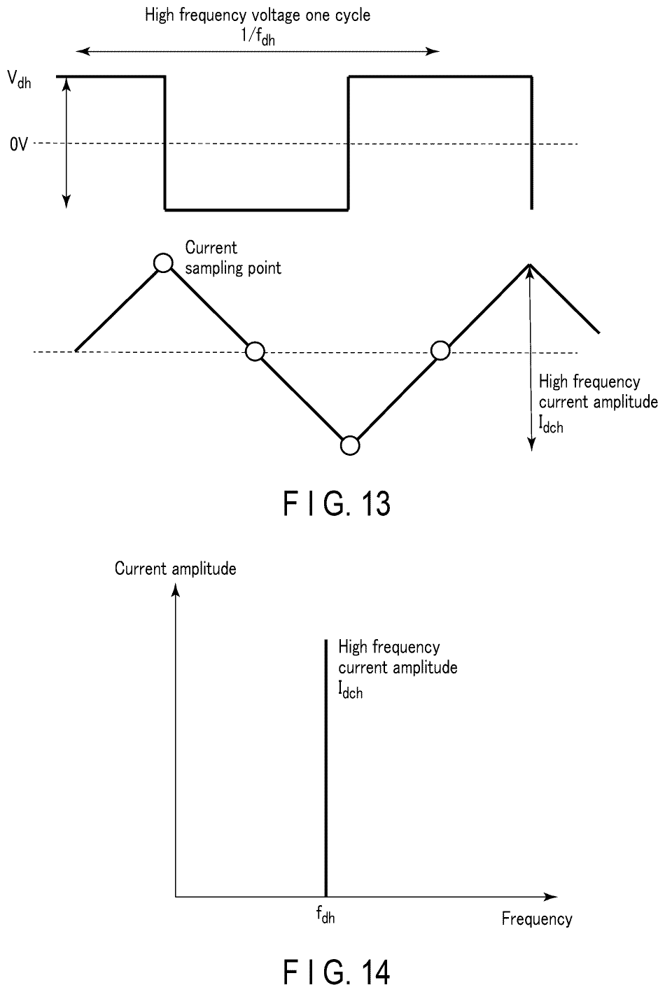

FIGS. 13 and 14 are diagrams for describing an example of the operation of the FFT analysis unit.

The harmonic current detection unit includes a band pass filter 6AA and an FFT analysis unit 6AB. The band pass filter 6AA receives the qc axis response current value (output current) I_{dc} from the coordinate (3Φ/dq) conversion unit 105, and extracts to output a high frequency current component I_{dc}′ of a band f_{dh} including a frequency equal to the frequency (superimposed high frequency voltage frequency) fₕ of the high frequency voltage command Vₕ.

The FFT analysis unit 6AB performs, for example, a fast Fourier transformation (FFT) analysis of the high frequency current component I_{dc}′ to detect the high frequency current amplitude I_{dch}. For example, the FFT analysis unit 6AB may acquire the high frequency current component I_{dc}′ and the high frequency voltage command Vₕ, sample the value of the high frequency current component I_{dc}′ at the timing of every ¼ cycle of the high frequency voltage, and detect the high frequency current amplitude I_{dch} from the difference between the sampled values.

The harmonic current detection unit can similarly detect the high frequency current amplitude I_{qch} for the q axis current.

The rotation speed estimation unit 6A can calculate the estimated value ωₑ_EST of the rotation angular velocity by calculating the rotation phase angle error Δθ from the above equation (10)′ using the high frequency current amplitude detected by the harmonic current detection unit and performing PLL control so that the rotation phase angle error Δθ converges to zero.

Note that it is also possible to calculate the estimated value of the initial position of the rotor of the synchronous machine M using the above-described method of calculating the estimated value of the angular velocity in the low-speed range.

In a case where the low-speed/high-speed flag is 1 (high speed), the rotation speed estimation unit 6A can calculate the estimated value ωₑ_EST of the rotation angular velocity using a method of observing the induced voltage of the synchronous machine M. Specifically, for example, in a case where the SynRM is rotating at a high speed, for example, the following method of calculating the estimated value ωₑ_EST of the rotation angular velocity based on the relationship between the output of the current controller and the feedforward voltage can be used.

The voltage equation in a case where the error Δθ occurs in the rotation phase angle is Expression (6), and at this time, the feedforward voltage command is Expression (11).

$$[ \begin{matrix}{v}_{d\_FF} \\ {v}_{q\_FF}\end{matrix} ] = [ \begin{matrix}{R}_{\_ set} & - {ω}_{e} {L}_{qa\_set} \\ {ω}_{e} {L}_{da\_set} & {R}_{\_ set}\end{matrix} ] [ \begin{matrix}{i}_{d c} \\ {i}_{qc}\end{matrix} ] \qquad ( 11 )$$

where R_ₛₑₜ is a motor winding resistance setting value, L_{da_set} is a d axis inductance setting value, and L_{qa_set} is a q axis inductance setting value.

Since the output of the current control (PI control) corresponds to the difference between Expressions (6) and (11), the following Expression (12) is obtained.

$$[ \begin{matrix}{E}_{d} \\ {E}_{q}\end{matrix} ] = [ \begin{matrix}{v}_{d c} - {v}_{d\_FF} \\ {v}_{q c} - {v}_{q\_FF}\end{matrix} ] = \{ [ \begin{matrix}0 & - {ω}_{e} {L}_{1} \\ - {ω}_{e} {L}_{1} & 0\end{matrix} ] \} [ \begin{matrix}{i}_{d c} \\ {i}_{qc}\end{matrix} ] + {ω}_{e} {L}_{1} [ \begin{matrix}- sin 2 Δθ & cos 2 Δθ \\ cos 2 Δθ & sin 2 Δθ\end{matrix} ] [ \begin{matrix}{i}_{d c} \\ {i}_{qc}\end{matrix} ] \qquad ( 12 )$$

In a case where there is no error between the motor parameter setting value and the rotation phase angle, values of Expression (12) are zero in both the dc axis component and the qc axis component. Focusing on the d axis component, Expression (13) is obtained.

$${E}_{d} = - {ω}_{e} {L}_{1} sin 2 Δθ \cdot {i}_{d c} + {ω}_{e} {L}_{1} ( 1 - cos 2 Δθ ) \cdot {i}_{qc} \qquad ( 13 )$$

Expression (13) is modified to Expression (14) when the axial error is sufficiently small.

$$Δθ = \frac{- {E}_{d}}{{ω}_{e} {L}_{1} {i}_{d c}} \qquad ( 14 )$$

The rotation speed estimation unit 6A can calculate the estimated value ωₑ_EST of the rotation angular velocity by calculating the rotation phase angle error Δθ calculated by Expression (14) and performing PLL control so that the rotation phase angle error Δθ converges to zero.

The estimated value ωₑ_EST of the rotation angular velocity calculated by the rotation speed estimation unit 6A is supplied to the rotation speed estimation unit 6A, and is also supplied to the switch 6E, the setting value comparison unit 6B, and the integration unit 6C.

The setting value comparison unit 6B operates when the operation mode flag is 1 (normal driving), compares the estimated value ωₑ_EST of the rotation angular velocity output from the rotation speed estimation unit 6A with a preset threshold value, and generates and outputs a value of the low-speed/high-speed flag indicating whether the synchronous machine M is in the low-speed range or the high-speed range. For example, the setting value comparison unit 6B sets the value of the low-speed/high-speed flag to zero (low speed) when the estimated value ωₑ_EST of the rotation angular velocity is equal to or less than the threshold value to output the value of the low-speed/high-speed flag to 1 (high speed) when the estimated value ωₑ_EST of the rotation angular velocity is larger than the threshold value.

The integration unit 6C integrates the estimated value ωₑ_EST of the rotation angular velocity calculated by the rotation speed estimation unit 6A, and calculates and outputs the estimated value θₑ_EST of the rotation angle. The estimated value θₑ_EST of the rotation angle calculated by the integration unit 6C is supplied to the rotation speed estimation unit 6A and the switch 6F.

The initial position estimation unit 6D calculates and outputs an estimated value of the initial position of the rotor 20 of the synchronous machine M according to the value of the initial position estimation flag. The initial position estimation unit 6D can calculate the estimated value of the initial position by, for example, a method similar to the method of calculating the estimated value of the rotation angle in the low-speed region of the synchronous machine M.

The switch 6E acquires the value of the estimated value ωₑ_EST of the rotation angular velocity, and switches the output value according to the value of the operation mode flag. The switch 6E outputs zero when the value of the operation mode flag is zero (parameter tuning operation), and outputs an estimated value ωₑ_EST of the rotation angular velocity calculated by the rotation speed estimation unit 6A when the value of the operation mode flag is 1 (normal driving).

The switch 6F acquires the values of the initial position estimation result of the rotor 20 of the synchronous machine M and the estimated value θₑ_EST of the rotation angle, and switches the output value according to the value of the operation mode flag. The switch 6F outputs the initial position estimation result of the rotor 20 of the synchronous machine M when the value of the operation mode flag is zero (parameter tuning operation), and outputs the estimated value θₑ_EST of the rotation angle calculated by the integration unit 6C when the value of the operation mode flag is 1 (normal driving).

In the rotation angle/speed arithmetic unit 106, the method of observing the d axis voltage is taken as an example, but it is also possible to adopt a method of observing the d axis and q axis voltages. In addition, this time, an example is described in which the estimated values of the rotation angle and the rotation angular velocity are calculated using a method focusing on the high frequency voltage and the high frequency current in the low-speed range and using a method focusing on the induced voltage in the high-speed range. The method of calculating the estimated values of the rotation angle and the rotation angular velocity is not limited to the above, and for example, a method using an extended induced voltage of a known technique can also be applied.

In addition, the sensorless control without using the angle/speed sensor is described as an example, but it is also possible to use a speed sensor such as a pulse generator (PG) or an angle sensor such as a resolver. In the case of using PG, the absolute position of the rotor is unknown, and thus it is necessary to estimate the initial position of the rotor. However, in the case of using a resolver, the high frequency signal superimposition for the initial position estimation in a short time can be omitted.

The parameter table TB includes a table storing a current-inductance relationship for each of the d axis current and the q axis current. The parameter table TB determines in which of the d axis table and the q axis table data should be stored according to the value of the d/q axis arithmetic flag, and switches between storage (during update) and use of the data according to the value of the storage/use flag. Therefore, while the motor parameter data stored in the table of the parameter table TB is used, the data update is not performed.

The parameter arithmetic unit 107 calculates the inductances L_{d} and L_{q} corresponding to the current values using the current values generated when the DC voltage is applied to the d axis and the q axis of the synchronous machine M.

The parameter arithmetic unit 107 calculates the inductances L_{d} and L_{q}, which are motor parameters, according to the values of the arithmetic execution flag and the d/q axis arithmetic flag. Hereinafter, an example of a method of calculating the inductances L_{d} and L_{q} will be described.

The voltage equation of the SynRM can be expressed by the following Expression (5) as described above.

$$[ \begin{matrix}{v}_{d} \\ {v}_{q}\end{matrix} ] = [ \begin{matrix}R + {pL}_{d} & - {ω}_{e} {L}_{q} \\ {ω}_{e} {L}_{d} & R + {pL}_{q}\end{matrix} ] [ \begin{matrix}{i}_{d} \\ {i}_{q}\end{matrix} ] \qquad ( 5 )$$

At the timing of calculating the inductances L_{d} and L_{q}, the rotation speed of the synchronous machine M is zero, and thus, when ω=0, Expression (5) is the following Expression (15).

$$[ \begin{matrix}{v}_{d} \\ {v}_{q}\end{matrix} ] = [ \begin{matrix}R + {pL}_{d} & 0 \\ 0 & R + {pL}_{q}\end{matrix} ] [ \begin{matrix}{i}_{d} \\ {i}_{q}\end{matrix} ] \qquad ( 15 )$$

(15) When the expression is modified by multiplying the currents i_{d} and i_{q} in Expression, the following Expression (16) is obtained.

$$[ \begin{matrix}{v}_{d} \\ {v}_{q}\end{matrix} ] = [ \begin{matrix}{Ri}_{d} + {pL}_{d} {i}_{d} & 0 \\ 0 & {Ri}_{q} + {pL}_{q} {i}_{q}\end{matrix} ] \qquad ( 16 )$$

Since the products of the inductances L_{d} and L_{q} and the currents i_{d} and i_{q} become the magnetic fluxes φ_{d} and φ_{q}, the following Expression (17) is used.

$$[ \begin{matrix}{ϕ}_{d} \\ {ϕ}_{q}\end{matrix} ] = [ \begin{matrix}{L}_{d} {i}_{d} & 0 \\ 0 & {L}_{q} {i}_{q}\end{matrix} ] \qquad ( 17 )$$

(16) The relationship between the voltage and the magnetic flux can be expressed by the following Expression (18) from Expressions (17).

$$[ \begin{matrix}{v}_{d} \\ {v}_{q}\end{matrix} ] = [ \begin{matrix}{Ri}_{d} + p {ϕ}_{d} & 0 \\ 0 & {Ri}_{q} + p {ϕ}_{q}\end{matrix} ] \qquad ( 18 )$$

The following Expression (19) is obtained by summarizing Expression (18) in terms of the magnetic flux of the d axis and the q axis.

$$[ \begin{matrix}p {ϕ}_{d} \\ p {ϕ}_{q}\end{matrix} ] = [ \begin{matrix}{v}_{d} - {Ri}_{d} \\ {v}_{q} - {Ri}_{q}\end{matrix} ] \qquad ( 19 )$$

(19) When both sides of Expression are integrated, magnetic fluxes α_{d} and α_{q} of the d axis and the q axis can be expressed by Expressions (20) and (21), respectively.

$${ϕ}_{d} = \int ( {v}_{d} - {Ri}_{d} ) dt \qquad ( 20 )$$

$${ϕ}_{q} = \int ( {v}_{q} - {Ri}_{q} ) dt \qquad ( 21 )$$

When Expressions (20) and (21) are substituted into the magnetic flux term in Expression (17), they can be expressed as the following Expressions (22) and (23).

$${L}_{d} {i}_{d} = \int ( {v}_{d} - {Ri}_{d} ) dt \qquad ( 22 )$$

$${L}_{q} {i}_{q} = \int ( {v}_{q} - {Ri}_{q} ) dt \qquad ( 23 )$$

Furthermore, by dividing both sides of Expressions (22) and (23) by the currents i_{d} and i_{q}, the inductances L_{d} and L_{q} can be calculated as in Expressions (24) and (25) below.

$${L}_{d} = \frac{1}{{i}_{d}} \int ( {v}_{d} - {Ri}_{d} ) dt \qquad ( 24 )$$

$${L}_{q} = \frac{1}{{i}_{q}} \int ( {v}_{q} - {Ri}_{q} ) dt \qquad ( 25 )$$

In a case where the above Expressions (24) and (25) are calculated by the microcomputer, dt is in control arithmetic cycle increments.

The parameter arithmetic unit 107 is configured to calculate the inductances L_{d} and L_{q} according to the above Expression (24) and Expression (25).

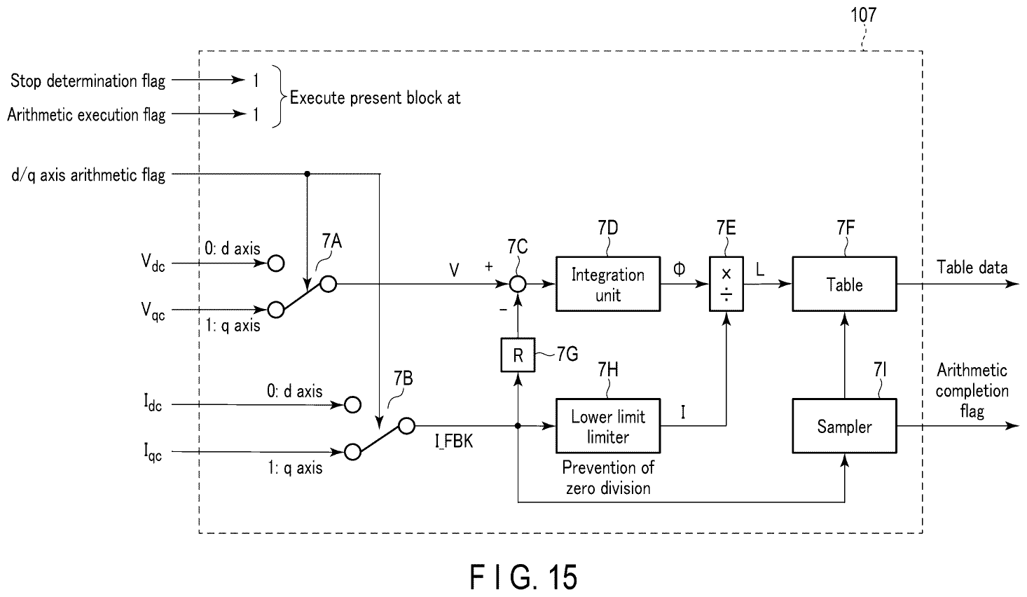

FIG. 15 is a diagram schematically illustrating a configuration example of a parameter arithmetic unit illustrated in FIG. 1.

The parameter arithmetic unit 107 has a function of acquiring values of an arithmetic execution flag, a d/q axis arithmetic flag, a stop determination flag, voltage commands V_{dc} and V_{qc} of the estimation rotation coordinate system, and currents I_{dc} and I_{qc} of the estimation rotation coordinate system, and calculating a motor parameter when the arithmetic execution flag is 1 and the stop determination flag is 1 (stop). In the present embodiment, the parameter arithmetic unit 107 calculates inductances L_{d} and L_{q} as motor parameters.

The parameter arithmetic unit 107 includes switches 7A and 7B, a subtraction unit 7C, an integration unit 7D, a division unit 7E, a table 7F, a resistance value multiplication unit 7G, a lower limit limiter 7H, and a sampler 7I.

The switch 7A acquires the voltage commands V_{dc} and V_{qc} of the estimation rotation coordinate system, and switches the output value according to the value of the d/q axis arithmetic flag. The switch 7A outputs the value of the voltage command V_{dc} of the dc axis when the d/q axis arithmetic flag is zero, and outputs the value of the voltage command V_{qc} of the qc axis when the d/q axis arithmetic flag is 1.

The switch 7B acquires the currents I_{dc} and I_{qc} in the sparse estimation rotation coordinate system, and switches the output value according to the value of the d/q axis arithmetic flag. The switch 7B outputs the value of the current I_{dc} of the dc axis when the d/q axis arithmetic flag is zero, and outputs the value of the current I_{qc} of the qc axis when the d/q axis arithmetic flag is 1.

The resistance value multiplication unit 7G calculates a product obtained by multiplying the output value I_FBK of the switch 7B by the value of the motor winding resistance R, and supplies the calculation result to the subtraction unit 7C.

The subtraction unit 7C calculates a difference obtained by subtracting the output value of the resistance value multiplication unit 7G from the output value V of the switch 7A, and supplies a calculation result to the integration unit 7D.

The integration unit 7D integrates the output value (V−R×I_FBK) of the subtraction unit 7C to calculate the magnetic flux Φ corresponding to Expression (20) and Expression (21) described above, and supplies the magnetic flux Φ to the division unit 7E.

The lower limit limiter 7H sets a lower limit value (>zero) of the output value of the switch 7B, outputs the input value I_FBK as the current value I in a case where a value I_FBK equal to or larger than the lower limit value is input, and outputs the lower limit value as the current value I in a case where a value I_FBK less than the lower limit value is input. As a result, the output value I of the lower limit limiter 7H is a value larger than zero, and zero division in the division unit 7E can be avoided.

The division unit 7E calculates a quotient obtained by dividing the magnetic flux Φ output from the integration unit 7D by the current value I output from the lower limit limiter 7H, and supplies the inductance value L corresponding to the above Expressions (24) and (25) to the table 7F.

The sampler 7I outputs a sampling signal corresponding to the timing at which the table 7F stores the inductance value L according to the output value (current value) I_FBK of the switch 7B. In the present embodiment, for example, the sampler 7I sets the maximum setting value of the current value I_FBK, and outputs the sampling signal so as to store the value of the inductance value L in the table 7F every time the output value I_FBK increases by 10% with the maximum setting value set to 100%. The maximum setting value of the current value I_FBK is, for example, a rated value of the current output from the inverter main circuit INV. The sampling signal may include information indicating the degree of achievement (10%, 20%, . . . , 100%) of the output value I_FBK.

The sampler 7I outputs the arithmetic completion flag as zero until the current value I_FBK reaches the maximum setting value, and outputs the arithmetic completion flag from zero to 1 in response to the current value I_FBK reaching the maximum setting value. When the current value I_FBK reaches the maximum setting value and the arithmetic completion flag changes from zero to 1, the parameter calculation of the parameter arithmetic unit 107 is completed.

The table 7F stores the relationship between the current value I_FBK and the inductance value L according to the sampling signal. When the storage of the inductance value L corresponding to the current value I_FBK 100% is completed, the table 7F outputs table data of the inductance value L corresponding to the current value I_FBK 10% to 100%.

Next, an example of an operation of performing parameter tuning in the inverter control apparatus and the synchronous machine driving apparatus according to the present embodiment will be described.

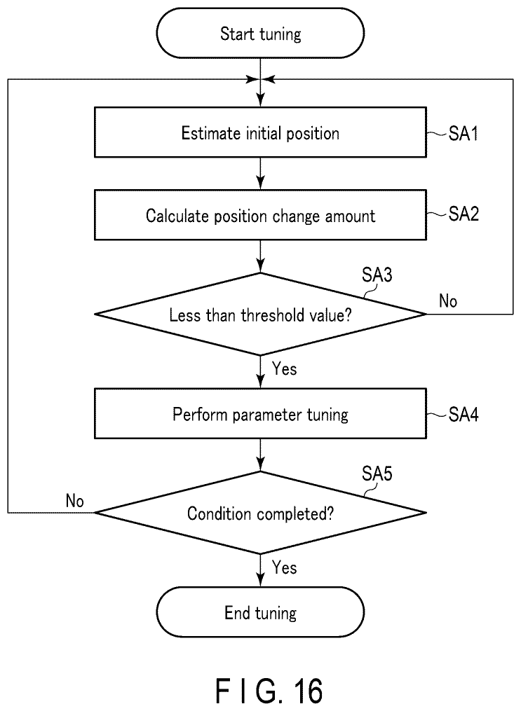

FIG. 16 is a flowchart illustrating an example of the operation of the inverter control apparatus and the synchronous machine driving apparatus according to the first embodiment.

When performing parameter tuning, the flag generation unit 108 sets the operation mode flag from 1 to zero, and starts generating a flag for performing parameter tuning. The flag generation unit 108 may perform parameter tuning by periodically setting the operation mode flag from 1 to zero, or may perform parameter tuning by setting the operation mode flag from 1 to zero according to an instruction from the host control apparatus or the like.

When the operation mode flag changes from 1 to zero, the inverter control apparatus 100 switches from the normal driving to the operation of parameter tuning. When parameter tuning is started, the flag generation unit 108 cyclically raises the initial position estimation flag.

While the initial position estimation flag rises, the high frequency voltage command Vₕ is output from the high frequency voltage superimposition unit 109, and the high frequency voltage command Vₕ is superimposed on the d axis voltage command V_{dc_p}.

For example, the rotation angle/speed arithmetic unit 106 calculates the rotation phase angle error Δθ by the above Expression (10) and Expression (10)′ and performs PLL control so that the rotation phase angle error Δθ converges to zero, thereby calculating the estimated value ωₑ_FBK of the rotation angular velocity and the estimated value θₑ_FBK of the rotation phase angle to estimate the initial position (step SA1).

Subsequently, the rotation determination unit 8A acquires the estimated value θₑ_FBK of the rotation phase angle calculated by the rotation angle/speed arithmetic unit 106, compares the latest value of the estimated value θₑ_FBK of the rotation phase angle with the previous value (step SA2), and generates and outputs the value of the stop determination flag indicating whether the rotor of the synchronous machine M is stopped.

At this time, the rotation determination unit 8A determines that the rotor 20 of the synchronous machine M is rotating when the difference between the latest value and the previous value of the estimated value θₑ_FBK of the rotation phase angle is greater than or equal to a predetermined threshold value (step SA3, No), maintains the stop determination flag at zero, and repeats steps SA1 to SA3 until the difference between the latest value and the previous value is less than the predetermined threshold value.

When the difference between the latest value and the previous value of the estimated value θₑ_FBK of the rotation phase angle is less than the predetermined threshold value, the rotation determination unit 8A determines that the rotor of the synchronous machine M is stopped (step SA3, Yes), and sets the stop determination flag to 1 (stop).

When the stop determination flag changes from zero to 1, parameter tuning is executed (step SA4).

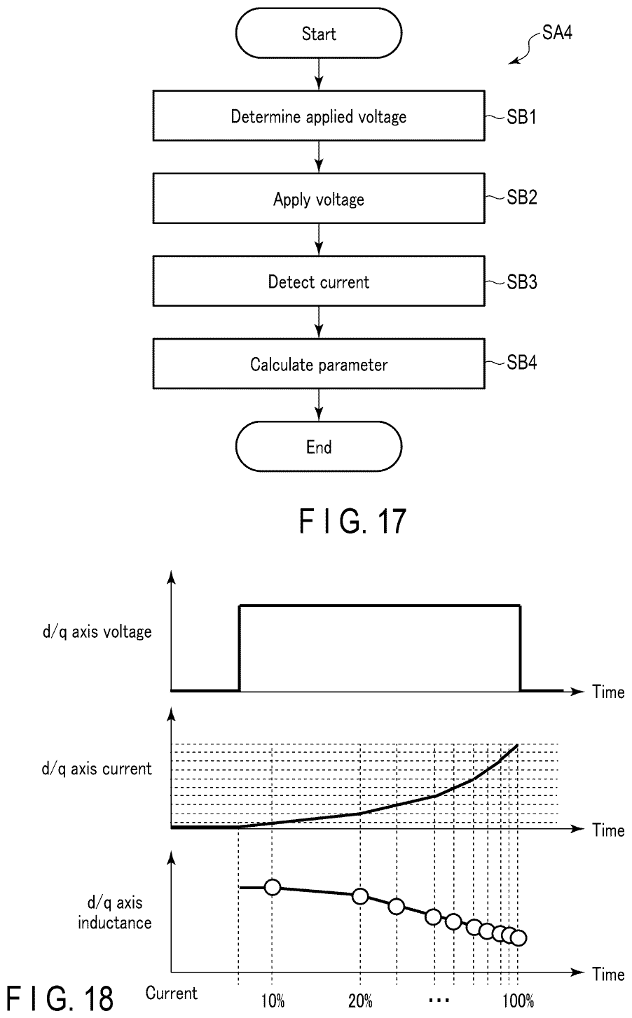

FIG. 17 is a flowchart illustrating an example of a parameter tuning operation in the inverter control apparatus and the synchronous machine driving apparatus according to the first embodiment.

FIG. 18 is a diagram for describing an example of table data generated by the parameter arithmetic unit illustrated in FIG. 15.

The voltage command generation unit 102 determines whether to apply the DC voltage to either the d axis or the q axis of the synchronous machine M according to the value of the d/q axis arithmetic flag, and outputs the voltage commands V_{dc} and V_{qc} (step SB1).

At this time, the voltage to be applied to the synchronous machine M may be determined in consideration of the final value of the flowing current. The relationship between the maximum setting value (final value) of the current flowing through the synchronous machine M and the applied voltage at the time of parameter tuning is expressed by the following Expressions (26) and (27).

$${i}_{d\_max} = \frac{{v}_{d}}{R} \qquad ( 26 )$$

$${i}_{q \_max} = \frac{{v}_{q}}{R} \qquad ( 27 )$$

The voltage command generation unit 102 may set the voltages v_{d} and v_{q} (Voltage command V_{dc} and V_{qc}) to be applied to the synchronous machine M so that the current flowing through the synchronous machine M is equal to or larger than the maximum setting values I_{d_max} and I_{q_max}. For example, in a case where the rated current value of the synchronous machine M is known in advance, for the desired maximum setting values I_{d_max} and I_{q_max} the rated current value of the electric motor M may be set as the maximum setting value (100%).

The coordinate (dq/3Φ) conversion unit 103 converts the voltage command values V_{dc} and V_{qc} supplied from the voltage command generation unit 102 into vector values Vu*, Vv*, and Vw* of the three-phase fixed coordinate system using the estimated value of the rotation angle, and outputs the vector values to the modulation unit 104.

The modulation unit 104 generates a gate command of the inverter main circuit INV using the three-phase voltage command values Vu*, Vv*, and Vw*, and outputs the gate command to the inverter main circuit INV.

The inverter INV performs switching according to the gate command and applies a DC voltage to one of the d axis and the q axis of the synchronous machine M (step SB2).

FIG. 18 illustrates an example of the calculation result of the current generated when the DC voltage is applied to one of the d axis and the q axis of the synchronous machine M and the inductance value. According to the example of FIG. 18, when the DC voltage is applied to the synchronous machine M, the current increases nonlinearly.

The parameter arithmetic unit 107 acquires the current values I_{dc} and I_{qc} calculated by the coordinate (3Φ/dq) conversion unit 105 to detect the current values (step SB3), and samples the calculated values of the inductances L_{d} and L_{q}, for example, every time the current values I_{dc} and I_{qc} increase by 10% (step SB4).

The parameter arithmetic unit 107 performs steps SB2 to SB4 until the current value reaches the maximum setting value (100%). When the current value reaches the maximum setting value, an arithmetic completion flag is set to 1, and the parameter arithmetic is completed.

When the arithmetic completion flag changes from zero to 1, the flag generation unit 108 sets the arithmetic execution flag to zero, raises the storage/use flag, and stores the table data output from the parameter arithmetic unit 107 in the table TB. In a case where the timing to tune the motor parameter is set in advance, the parameter arithmetic unit 107 may reset the arithmetic completion flag to zero in accordance with the timing. For example, in a case where a command to tune the motor parameter is acquired from the host controller, the parameter arithmetic unit may set the arithmetic completion flag to zero according to the command.

Subsequently, the flag generation unit 108 changes the value of the d/q axis arithmetic flag and raises the arithmetic execution flag. After confirming that the rotor 20 of the synchronous machine M is stopped, as in steps SA1 to SA4 described above, the parameter arithmetic unit 107 starts the arithmetic of the motor parameter for the conduction phase (either the d axis or the q axis) for which a new motor parameter has not been calculated yet.

When the arithmetic completion flag is 1 and the arithmetic of the motor parameters of both the d axis and the q axis is completed, the flag generation unit 108 determines whether the arithmetic of the parameters is completed under all conditions (step SA5). For example, the condition for calculating the motor parameter may be set in the flag generation unit 108 in advance.

In a case where there is a condition under which the motor parameter has not been calculated yet (step SA5, No), the flag generation unit 108 performs the above-described steps SA1 to SA4 for each arithmetic condition to calculate the motor parameter for each of the d axis and the q axis and updates the table TB.

In a case where the arithmetic of the motor parameter is completed under all the conditions (step SA5, Yes), the flag generation unit 108 sets the arithmetic execution flag to zero, raises the storage/use flag, and stores the table data output from the parameter arithmetic unit 107 in the table TB. Thereafter, the flag generation unit 108 resets the d/q axis arithmetic flag after the table TB is updated, raises the operation mode flag after a predetermined period (sets the flag to 1), ends the parameter tuning, and starts the normal driving operation of the inverter control apparatus 100.

As described above, the inverter control apparatus and the synchronous machine driving apparatus according to the present embodiment can calculate the inductances L_{d} and L_{q}, which are motor parameters, by applying a DC voltage to the d axis or the q axis and observing the d axis or q axis current generated at the time. According to the inverter control apparatus and the synchronous machine driving apparatus of the present embodiment, in a case where the synchronous machine time constant (τ=L/R) is small, the acquisition of the motor parameter can be completed in a relatively short time. In the present embodiment, the high frequency voltage command is superimposed on the voltage command when the initial position of the rotor 20 of the synchronous machine M is estimated, but the high frequency voltage command may be superimposed only for a short time when the initial position is estimated, and generation of noise and vibration for a long time is avoided.

That is, according to the present embodiment, it is possible to provide an inverter control apparatus and a synchronous machine driving apparatus that suppress deterioration in reliability and comfort.

In the operation of parameter tuning described above, the inverter control apparatus and the synchronous machine driving apparatus calculate the motor parameter only once under the same arithmetic condition. The accuracy of the motor parameter can be further improved by taking an average value of a plurality of parameters calculated by repeating the same sequence several times under the same arithmetic condition or performing post-processing such as omitting outliers.

In the above embodiment, the description of providing the dead time in the gate command of the inverter main circuit INV in order to prevent the element short circuit in the inverter main circuit INV is omitted. Actually, since the dead time is provided in the gate command of the inverter main circuit INV, the actual value of the output voltage of the inverter main circuit INV deviates from the command value by the dead time. Therefore, it is desirable to correct the deviation between the command value and the actual value (dead time compensation). For example, a method of correcting the gate command according to the polarity of the phase current may be used. Alternatively, a method of directly or indirectly (for example, performing voltage/frequency conversion) acquiring a PWM voltage by a voltage sensor and correcting a voltage command value by feedback control may be used. The accuracy of the motor parameter arithmetic can be improved by performing dead time compensation.

In addition, in the above-described embodiment, the method of calculating the motor parameter (inductances L_{d}, L_{q}) using each amount of the dq rotation coordinate system is described, but even when the motor parameter is calculated using the voltage command obtained by converting the value of the dq rotation coordinate system into the value of the three-phase fixed coordinate system and the current detection value, a similar effect can be obtained.

Next, modifications of the inverter control apparatus and the synchronous machine driving apparatus according to the first embodiment will be described. In the description of the modifications and the embodiments described below, the same reference numerals are given to the same configurations as those of the above-described first embodiment, and the description thereof will be omitted.

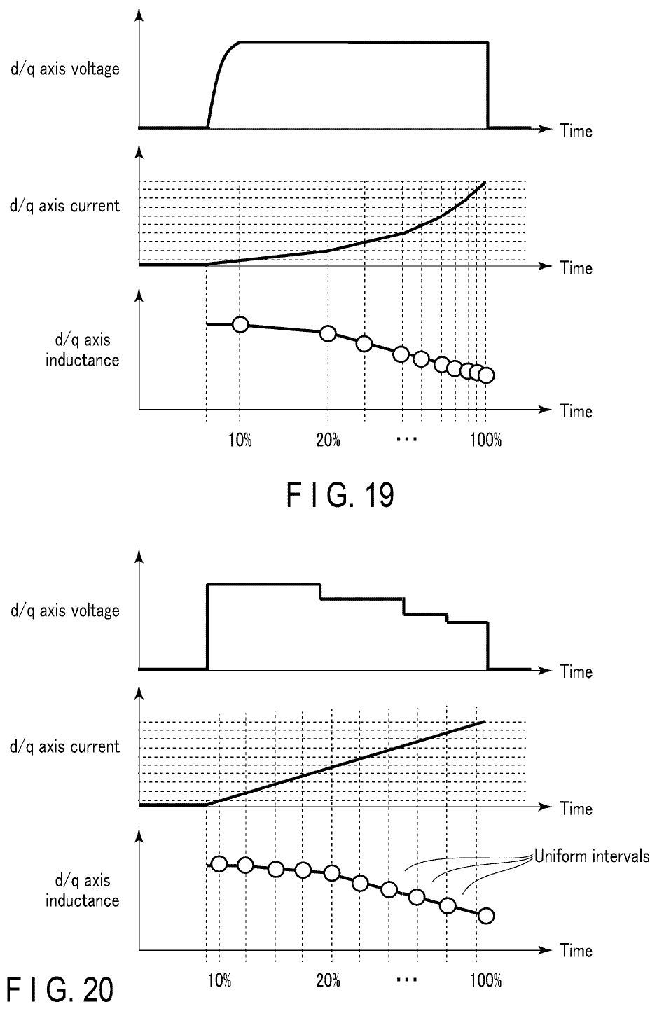

FIG. 19 is a diagram for describing the first modification of the table data generated by the parameter arithmetic unit illustrated in FIG. 15.

In the first embodiment described above, the example in which the voltage command generation unit 102 increases the DC voltage command stepwise is described. In the first modification, the voltage command generation unit 102 generates the DC voltage command so that the command rises gently.

For example, in a case where the DC voltage command increases stepwise, the output current of the inverter main circuit INV may instantaneously jump up, and the accuracy of the current detection value may decrease. When the accuracy of the current detection value decreases, it is difficult to accurately determine the sampling timing of the motor parameter. Therefore, in the first modification, by slowly raising the DC voltage command, a transient response in which the output current of the inverter main circuit INV instantaneously jumps is suppressed. As a result, the parameter arithmetic unit 107 can accurately acquire the sampling timing of the motor parameter, and can reduce the parameter calculation error.

FIG. 20 is a diagram for describing the second modification of the table data generated by the parameter arithmetic unit illustrated in FIG. 15.

In the first embodiment described above, the voltage command generation unit 102 generates the DC voltage command so as to apply a constant DC voltage to the synchronous machine M. In a case where a constant DC voltage is applied to the synchronous machine M, the current increases according to the time constant, and thus the sampling timing of the motor parameter is denser as the current increases. In a case of driving the synchronous machine M in which the change in the current is fast, the parameter arithmetic unit 107 may miss the arithmetic result of the motor parameter.

Therefore, in the second modification, for example, the voltage command generation unit 102 adjusts the DC voltage command value according to the current level so that the change amount of the output current of the inverter main circuit INV is substantially constant. By controlling the voltage according to the magnitude of the current, the sampling interval of the motor parameter can be equalized as real time, and the parameter arithmetic unit 107 can accurately sample the arithmetic result of the motor parameter. Further, according to the second modification, it is possible to suppress sudden rotation of the synchronous machine M due to a rapid increase in the output current of the inverter main circuit INV.

The voltage command generation unit 102 may generate the DC voltage command by combining the first modification and the second modification. In any case, the same effects as those of the inverter control apparatus and the synchronous machine driving apparatus according to the first embodiment described above can be obtained.

Next, an inverter control apparatus and a synchronous machine driving apparatus according to a second embodiment will be described in detail with reference to the drawings.

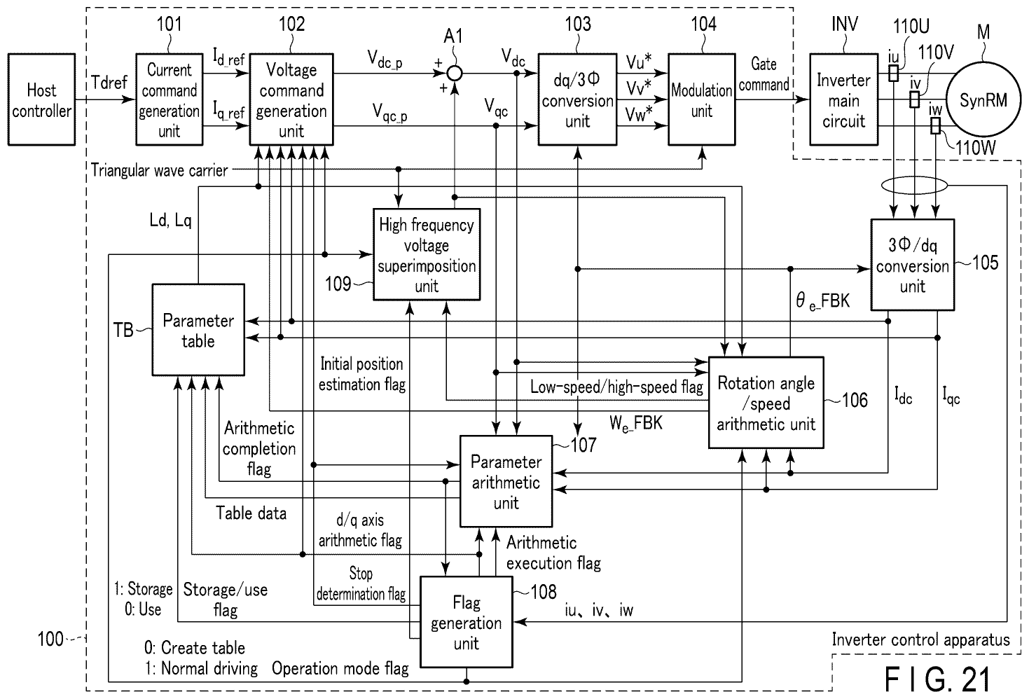

FIG. 21 is a block diagram schematically illustrating a configuration example of an inverter control apparatus and a synchronous machine driving apparatus according to the second embodiment.

In the first embodiment described above, it has been confirmed that the rotation of the synchronous machine M is stopped by estimating the initial position of the rotor 20 of the synchronous machine M. In the present embodiment, the motor parameter is tuned after a sufficient amount of current is flown into the synchronous machine M by applying a DC voltage to the q axis of the synchronous machine M having a high inductance to retract the rotor 20, and torque corresponding to the current is generated to stop the rotation of the synchronous machine M. In the present embodiment, since the initial position estimation is not performed during the parameter tuning, the value of the initial position estimation flag is zero during the period in which the parameter tuning is performed.

The inverter control apparatus 100 according to the present embodiment is different from that of the first embodiment in the configurations of the voltage command generation unit 102 and the flag generation unit 108.

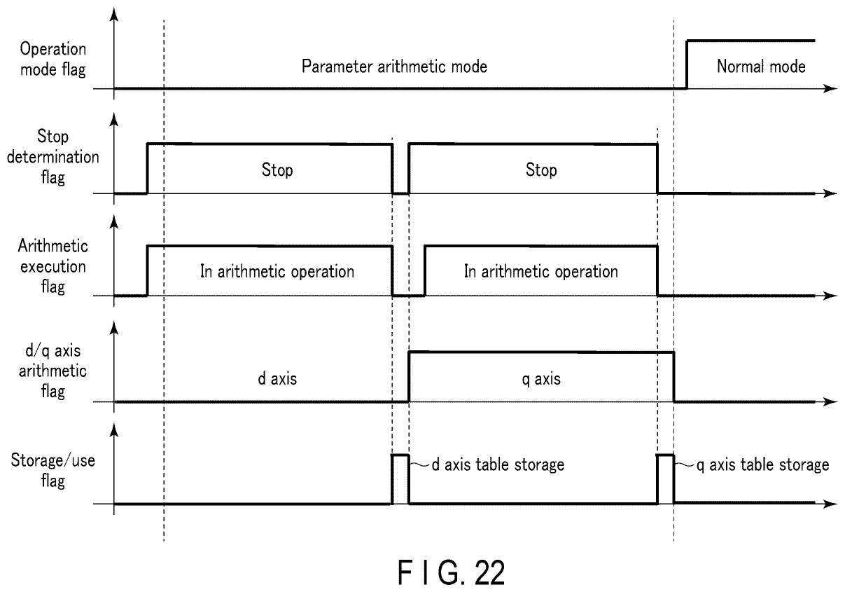

FIG. 22 is a diagram schematically illustrating an example of flags generated by the flag generation unit illustrated in FIG. 21.

In the present embodiment, since the initial position estimation is not performed in the parameter calculation mode, the description of the initial position estimation flag is omitted in FIG. 22.

After the operation mode flag is zero and the stop determination flag is zero, the flag generation unit 108 sets the arithmetic execution flag from zero to 1 and causes the parameter arithmetic unit 107 to perform parameter tuning.

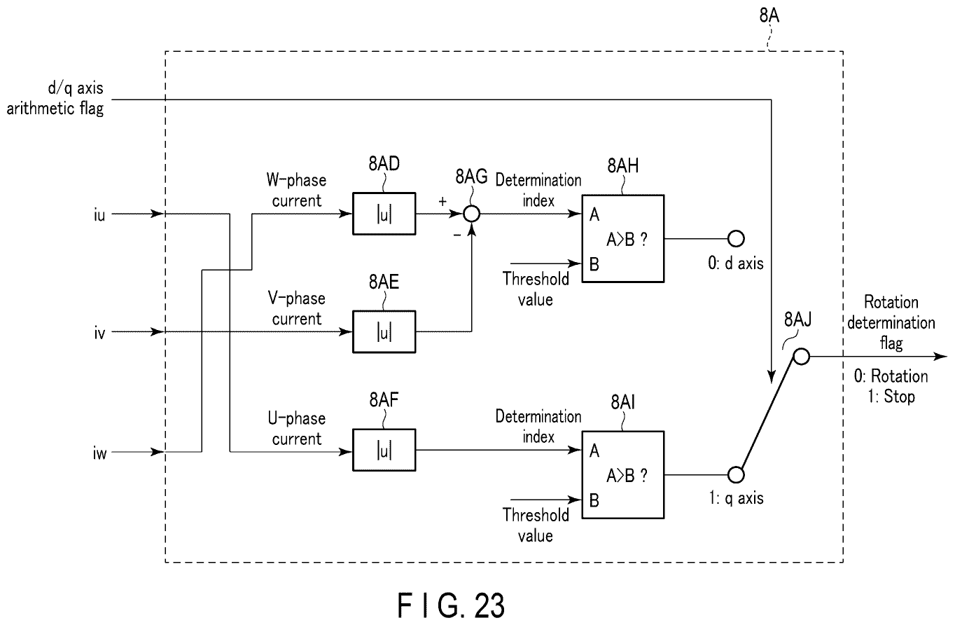

FIG. 23 is a block diagram schematically illustrating a configuration example of a rotation determination unit of the flag generation unit illustrated in FIG. 21.

The rotation determination unit 8A determines the stop state by changing the current to be observed (d axis current, q axis current) according to which motor parameter of the d axis or the q axis is calculated. The stop determination flag is set to 1 in a case where it is determined that the synchronous machine M is stopped, and is set to zero in a case where it is determined that the synchronous machine M is rotating.

In a case where a DC voltage is applied to the q axis, the U-phase current is ideally zero. However, the rotation of the rotor 20 increases or decreases the current from zero. In the present embodiment, the rotation determination unit 8A determines the rotation of the rotor 20 by capturing the change in the U-phase current. In addition, in a case where a DC voltage is applied to the d axis, ideally, only a U-phase current flows, and no current flows in the V-phase and the W-phase. Therefore, the rotation determination unit 8A determines the rotation of the rotor 20 by observing the difference between the current values of the V-phase and the W-phase and zero.

The rotation determination unit 8A includes absolute value calculation units 8AD to 8AF, a subtraction unit 8AG, comparison units 8AH and 8AI, and a switching unit 8AJ.

The absolute value calculation unit 8AD acquires the detection value iu of the U-phase output current of the inverter main circuit INV, and calculates and outputs an absolute value of the detection value iu.

The absolute value calculation unit 8AE acquires the detection value iv of the V-phase output current of the inverter main circuit INV, and calculates and outputs an absolute value of the detection value iv.

The absolute value calculation unit 8AF acquires the detection value iw of the W-phase output current of the inverter main circuit INV, and calculates and outputs an absolute value of the detection value iw.

The subtraction unit 8AG calculates and outputs a difference obtained by subtracting the output value of the absolute value calculation unit 8AE from the output value of the absolute value calculation unit 8AD.

The comparison unit 8AH sets the output value of the subtraction unit 8AG as the determination index A to output a result of comparing the determination index A with the threshold value B. The comparison unit 8AH outputs zero (rotation) in a case where the determination index A is larger than the threshold value B, and outputs one (stop) in a case where the determination index A is equal to or smaller than the threshold value B.

The comparison unit 8AI sets the output value of the absolute value calculation unit 8AF as the determination index A to output a result of comparing the determination index A with the threshold value B. Note that the threshold value B in the comparison unit 8AH and the threshold value B in the comparison unit 8AI may have different values or the same value. The comparison unit 8AI outputs zero (rotation) in a case where the determination index A is larger than the threshold value B, and outputs 1 (stop) in a case where the determination index A is equal to or less than the threshold value B.

The switching unit 8AJ switches the output value of the rotation determination unit 8A according to the value of the d/q axis arithmetic flag. When the value of the d/q axis arithmetic flag is zero (d axis), the switching unit 8AJ outputs the output value of the comparison unit 8AH as the value of the stop determination flag, and when the value of the d/q axis arithmetic flag is 1 (q axis), the switching unit 8AJ outputs the output value of the comparison unit 8AI as the value of the stop determination flag.

Note that the rotation determination unit 8A may output a value corresponding to the value of the d/q axis arithmetic flag after resetting the value of the stop determination flag to zero at the timing when the value of the d/q axis arithmetic flag is switched.

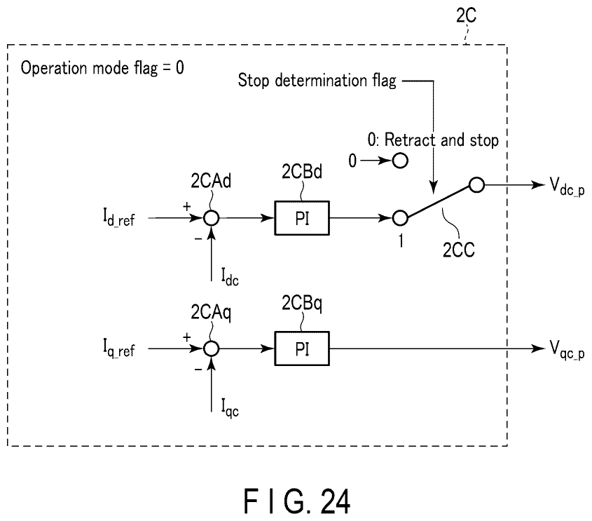

FIG. 24 is a block diagram schematically illustrating a configuration example of the voltage command generation unit illustrated in FIG. 21. FIG. 24 illustrates a functional block of the voltage command generation unit 102 operating in the parameter calculation mode. The functional block of the voltage command generation unit 102 that performs the normal driving operation are similar to that of the above-described first embodiment.

In the present embodiment, the voltage command generation unit 102 includes at least a normal driving function unit 2B and a rotation stop command generation unit 2C.

The rotation stop command generation unit 2C operates when the value of the operation mode flag is zero. When the value of the stop determination flag is zero, the rotation stop command generation unit 2C performs current control only for one conduction phase of the d axis and the q axis, and sets the value of the DC voltage command to zero for the other conduction phase. In the example illustrated in FIG. 24, when the value of the stop determination flag is zero, the rotation stop command generation unit 2C performs the current control only for the q axis, and sets the value of the DC voltage command to zero for the d axis.

The rotation stop command generation unit 2C includes subtraction units 2CAd and 2CAq, PI control units 2CBd and 2CBq, and a switch 2CC.

The subtraction unit 2CAd calculates and outputs a difference (I_{d_ref}−I_{dc}) between the d axis current command I_{d_ref} and the q axis current I_{dc} in the estimation rotation coordinate system.

The subtraction unit 2CAq calculates and outputs a difference (I_{q_ref}−I_{qc}) between q axis current command I_{q_ref} and q axis current I_{qc} in the estimation rotation coordinate system.

The PI control unit 2CBd acquires the output value of the subtraction unit 2CAd, performs PI control so that the difference between the d axis current command I_{d_ref} and the d axis current I_{dc} in the estimation rotation coordinate system follows zero, calculates the d axis voltage command V_{dc_p}, and outputs the d axis voltage command V_{dc_p} to the switch 2CC.

The PI control unit 2CBq acquires an output value of the subtraction unit 2CAq, performs PI control so that a difference between the q axis current command I_{q_ref} and the q axis current I_{qc} in the estimation rotation coordinate system follows zero, and calculates and outputs a d axis voltage command V_{qc_p}.

In addition, the switch 2CC outputs the value of the d axis voltage command V_{dc_p} as zero when the operation mode flag is zero and the stop determination flag is zero, and outputs the output value of the PI control unit 2CBd as the value of the d axis voltage command V_{dc_p} when the operation mode flag is zero and the stop determination flag is 1.

The values of the voltage commands V_{dc_p} and V_{qc_p} output from the rotation stop command generation unit 2C are input to the coordinate (dq/3Φ) conversion unit 103.

By generating the voltage command as described above, in the present embodiment, the rotor 20 can be fixed at an intended angle by retracting the rotor 20 instead of measuring the position at which the rotor has stopped. In the above example, when the stop determination flag is zero, the current control is performed only for the q axis, and the value of the DC voltage command is zero for the d axis. Using the voltage command value generated in this manner, a DC voltage is applied to the q axis having the highest inductance (which easily generates a magnetic flux) to generate a magnetic flux targeted for the q axis, and a rotational position can be retracted.

Note that, in a case where the synchronous machine M is the SynRM, the conduction phase that is most likely to generate the magnetic flux is the q axis, and in a case where the synchronous machine M is another type of synchronous machine, the d axis is basically the conduction phase that is most likely to generate the magnetic flux.

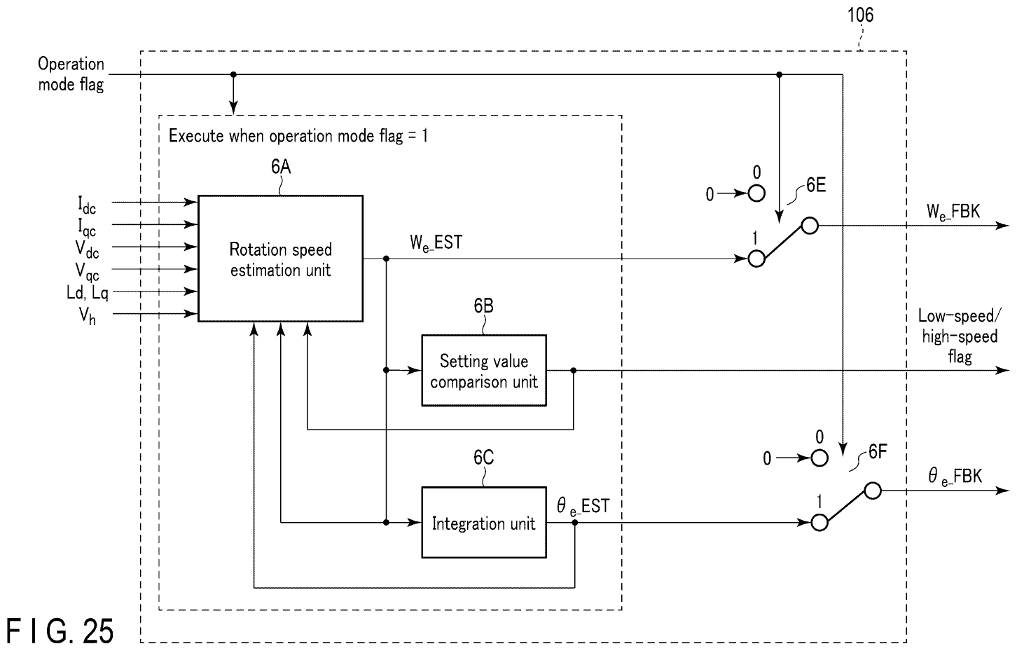

FIG. 25 is a block diagram schematically illustrating a configuration example of the rotation angle/speed arithmetic unit illustrated in FIG. 21.

In the present embodiment, the rotation angle/speed arithmetic unit 106 is different from that of the first embodiment in the output value of the switch 6F.

The switch 6F acquires values of zero and the estimated value θₑ_EST of the rotation angle, and switches the output value according to the value of the operation mode flag. The switch 6F outputs zero when the value of the operation mode flag is zero (parameter tuning operation), and outputs the estimated value θₑ_EST of the rotation angle calculated by the integration unit 6C when the value of the operation mode flag is 1 (normal driving). This is a state in which the d axis of the synchronous machine M and the U-phase winding face each other since the synchronous machine M is retracted to the intended axis (θ=90°) and stopped. In this case, the rotation phase angle θₑ_FBK is fixed to zero.

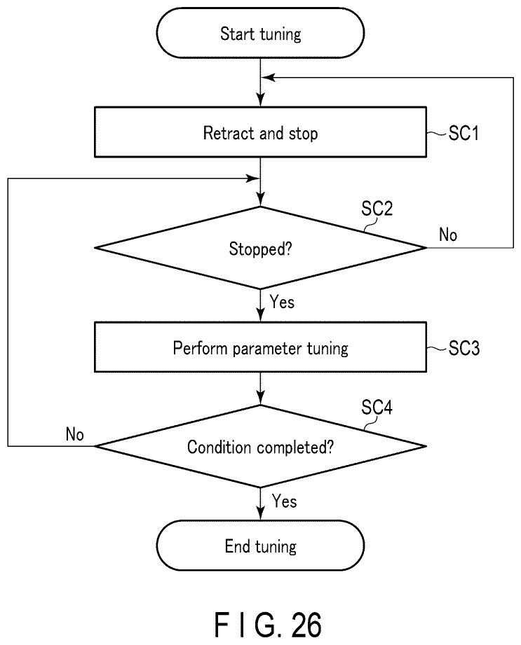

FIG. 26 is a flowchart illustrating an example of the operation of the inverter control apparatus and the synchronous machine driving apparatus according to the second embodiment.

When the operation mode flag is zero, parameter tuning is started. When parameter tuning is started, the value of the stop determination flag is zero (rotation). When the values of the operation mode flag and the stop determination flag are zero, the voltage command generation unit 102 generates a voltage command to fix the rotor 20 of the synchronous machine M to an intended angle by retracting the rotor. The inverter main circuit INV is controlled using the voltage command to stop the rotation output from the voltage command generation unit 102, and the rotor 20 of the synchronous machine M is stopped (step SC1).

Subsequently, the rotation determination unit 8A of the flag generation unit 108 outputs the value of the stop determination flag indicating whether the rotor 20 of the synchronous machine M is stopped according to the value of the d/q axis arithmetic flag and the values of the output current values iu, iv, and iw of the inverter main circuit INV.

When the stop determination flag changes from zero (rotation) to 1 (stop) (step SC2, Yes), parameter tuning is executed (step SC3). The operation of parameter tuning is similar to that of the first embodiment described above.

Subsequently, the flag generation unit 108 changes the value of the d/q axis arithmetic flag and raises the arithmetic execution flag. After confirming that the rotor 20 of the synchronous machine M is stopped, as in steps SC2 to SC3 described above, the parameter arithmetic unit 107 starts the arithmetic of the motor parameter for the conduction phase (either the d axis or the q axis) for which a new motor parameter has not been calculated yet.

When the arithmetic completion flag is 1 and the arithmetic of the motor parameters of both the d axis and the q axis is completed, the flag generation unit 108 determines whether the arithmetic of the parameters is completed under all conditions (step SC4). For example, the condition for calculating the motor parameter may be set in the flag generation unit 108 in advance.

In a case where there is a condition under which the motor parameter has not been calculated yet (step SC4, No), the flag generation unit 108 performs the above-described steps SC2 to SC3 for each arithmetic condition to calculate the motor parameter for each of the d axis and the q axis and update the table TB.

In a case where the arithmetic of the motor parameter is completed under all the conditions (step SC4, Yes), the flag generation unit 108 sets the arithmetic execution flag to zero, raises the storage/use flag to zero, and stores the table data output from the parameter arithmetic unit 107 in the table TB. Thereafter, the flag generation unit 108 resets the d/q axis arithmetic flag after the table TB is updated, raises the operation mode flag after a predetermined period (sets the flag to 1), ends the parameter tuning, and starts the normal driving operation of the inverter control apparatus 100.

As described above, the inverter control apparatus and the synchronous machine driving apparatus according to the present embodiment can calculate the inductances L_{d} and L_{q}, which are motor parameters, by applying a DC voltage to the d axis or the q axis and observing the d axis or q axis current generated at the time. According to the inverter control apparatus and the synchronous machine driving apparatus of the present embodiment, in a case where the synchronous machine time constant (τ=L/R) is small, the acquisition of the motor parameter can be completed in a relatively short time.

According to the inverter control apparatus and the synchronous machine driving apparatus of the present embodiment, the rotor 20 can be actively stopped in a case where the rotation of the synchronous machine M is not stopped, and the inductance characteristic of the d axis or the q axis can be more accurately acquired. That is, in the present embodiment, by retracting and stopping the rotor 20, the motor parameter can be calculated by stopping the rotor 20 at an intended stop point every time. This improves the calculation accuracy of the motor parameter. In addition, even in a case where the rotor 20 rotates, it is possible to immediately stop the rotor 20 at an intended angle and execute the arithmetic of the motor parameter.

That is, according to the present embodiment, it is possible to provide an inverter control apparatus and a synchronous machine driving apparatus that suppress deterioration in reliability and comfort.

In the present embodiment, after the arithmetic of all the motor parameters by the parameter arithmetic unit 107 is completed and the motor parameters are stored in the table TB, the initial position estimation may be performed when shifting to the normal driving operation. In this way, the accuracy of the calculation of the estimated value of the rotation phase angle is improved, and the rotation of the synchronous machine M can be smoothly accelerated after shifting to the normal driving operation.

Next, modifications of the inverter control apparatus and the synchronous machine driving apparatus according to the second embodiment will be described.

In the first and second embodiments described above, the parameter arithmetic unit 107 calculates the d/q axis inductances L_{d} and L_{q} as the motor parameters, but in the present comparative example, an example in which the parameter arithmetic unit 107 further calculates the motor winding resistance of the synchronous machine M will be described.

In the inverter control apparatus of the present comparative example, the parameter arithmetic unit 107 includes a resistance calculation unit 7J.

In the present comparative example, the parameter arithmetic unit 107 acquires the value of the operation mode flag, and the resistance calculation unit 7J calculates the resistance value R when the operation mode flag is zero (motor parameter tuning operation). The value of the motor winding resistance R calculated by the resistance calculation unit 7J is used by the resistance value multiplication unit 7G of the parameter arithmetic unit 107 illustrated in FIG. 15.

The resistance calculation unit 7J acquires values of the angular velocity θ, the d axis current I_{d}_FBK, the q axis current I_{q}_FBK, and the q axis current command I_{q_ref}.

In the present specification, the d axis current I_{d}_FBK and the q axis current I_{q}_FBK can be treated as the same values as the d axis current I_{dc} and the q axis current I_{qc} in the dcqc estimation coordinate system. The d axis current I_{dc} and the q axis current I_{qc} in the dcqc estimation coordinate system are the d axis current and the q axis current observed on the estimation coordinates (θₑ_FBK) calculated without using an angle sensor or a speed sensor. The d axis current I_{d}_FBK and the q axis current I_{q}_FBK are feedback values including the d axis current I_{dc} and the q axis current I_{qc} observed on the estimation coordinates and the d axis current and the q axis current observed on the coordinates acquired using the sensor. In the present specification, for values other than the d axis current and the q axis current, a subscript c is added to the reference numeral for the value observed on the estimation coordinates, and “_FBK” is added to the reference numeral for the feedback value including the value observed on the estimation coordinates and the value observed on the coordinates using the sensor.

In the second embodiment, when the motor parameter tuning operation is started, the rotor 20 of the synchronous machine M is stopped by retraction, so that the angular velocity θ is zero. At this time, in a case where the q axis current I_{q}_FBK can be calculated according to the command I_{q_ref} value, the relationship between the voltage and the current is expressed by Expression (28).

$${V}_{q} = {RI}_{q\_ref} \qquad ( 28 )$$

When both sides of the above Expression (28) are divided by the q axis current command I_{q_ref} value, the motor winding resistance R is expressed by the following Expression (29).

$$R = \frac{{V}_{q}}{{I}_{q\_ref}} \qquad ( 29 )$$

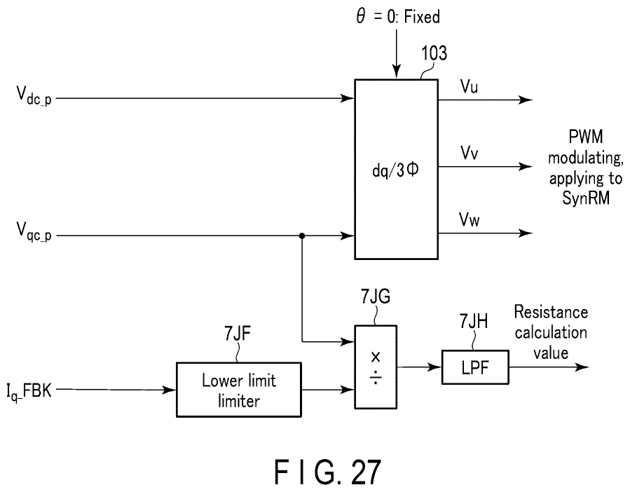

FIG. 27 is a diagram schematically illustrating a configuration of a resistance calculation unit of the parameter arithmetic unit illustrated in FIG. 21.

The resistance calculation unit 7J includes a lower limit limiter 7JF, a division unit 7JG, and a low-pass filter 7JH.

The lower limit limiter 7JF compares the q axis current I_{q}_FBK value with the threshold value, and outputs the threshold value when the q axis current I_{q}_FBK value is equal to or smaller than the threshold value, and outputs the q axis current I_{q}_FBK value when the q axis current I_{q}_FBK value is larger than the threshold value. Since the current flowing to the synchronous machine M is small immediately after the start of the current application, the lower limit limiter 7JF is provided from the viewpoint of preventing zero division to avoid the value serving as the denominator from becoming zero.

The division unit 7JG outputs a value (V_{q}/I_{q}_FBK) obtained by dividing the output value of the PI control unit 7JD by the output value of the lower limit limiter 7JF.

The low-pass filter 7JH outputs a value obtained by removing frequency components equal to or more than a predetermined threshold value from the output value of the division unit 7JG. The ripple effect due to the PWM control included in the output value of the division unit 7JG can be reduced by the low-pass filter 7JH.

The resistance calculation unit 7J outputs the output value of the low-pass filter 7JH as the value of the motor winding resistance R.

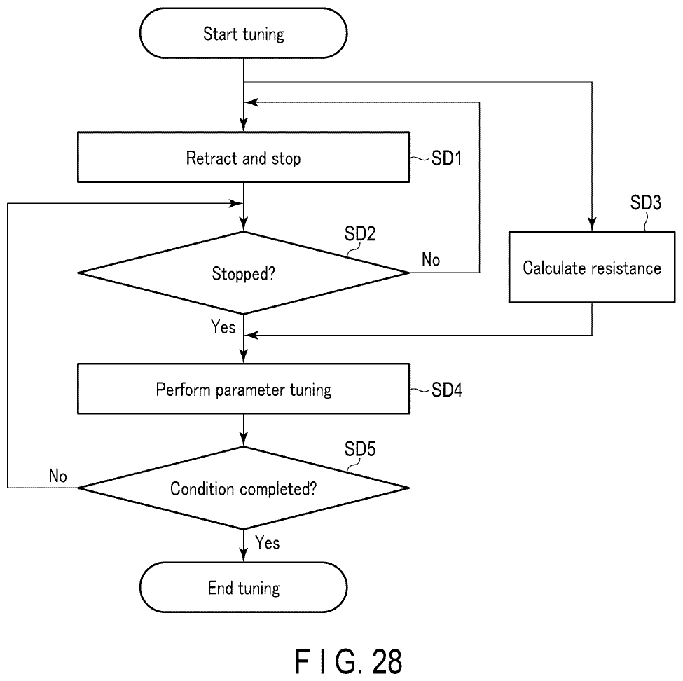

FIG. 28 is a flowchart illustrating an example of the operation of the inverter control apparatus and the synchronous machine driving apparatus according to the modification of the second embodiment.

When the operation mode flag is zero (motor parameter tuning operation), parameter tuning is started. When parameter tuning is started, the value of the stop determination flag is zero (rotation). When the values of the operation mode flag and the stop determination flag are zero, the voltage command generation unit 102 generates a voltage command to fix the rotor 20 of the synchronous machine M to an intended angle by retracting the rotor. The inverter main circuit INV is controlled using the voltage command to stop the rotation output from the voltage command generation unit 102, and the rotor 20 of the synchronous machine M is stopped (step SD1).

Subsequently, the rotation determination unit 8A of the flag generation unit 108 determines whether the rotor 20 of the synchronous machine M is stopped according to the value of the d/q axis arithmetic flag and the values of the output current values iu, iv, and iw of the inverter main circuit INV (step SD2), and outputs the value (1: stop, zero: rotation) of the stop determination flag indicating the determination result.

In parallel with the flag generation unit 108 performing the stop determination, the parameter arithmetic unit 107 calculates the value of the motor winding resistance R (step SD3).

When the stop determination flag changes from zero (rotation) to 1 (stop) (step SD2, Yes), parameter tuning is executed (step SD4). The operation of parameter tuning is similar to that of the first embodiment described above. At this time, the parameter arithmetic unit 107 calculates the inductance L_{d} and L_{q} values using the value of the motor winding resistance R calculated by the resistance calculation unit 7J according to the value of the d/q axis arithmetic flag.

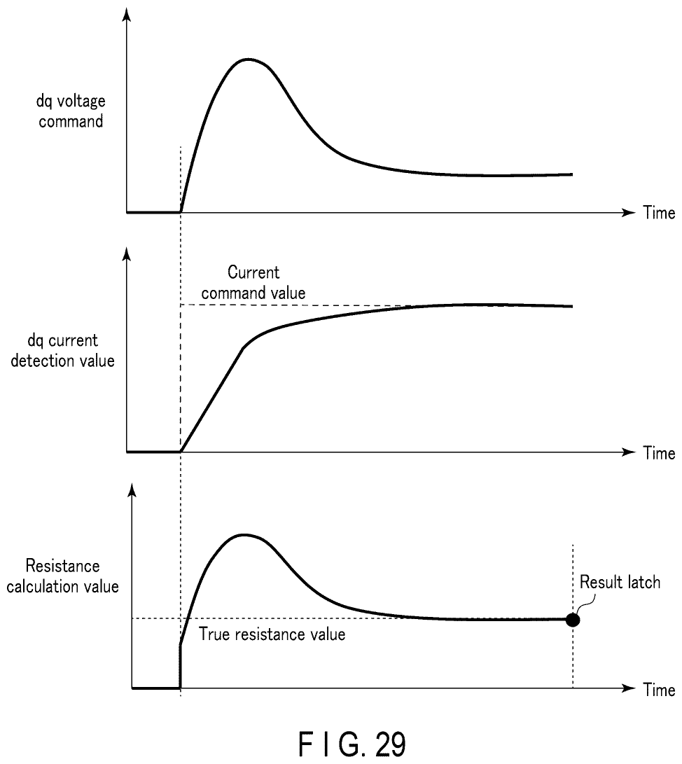

FIG. 29 is a diagram illustrating an example of timing at which the parameter arithmetic unit of the inverter control apparatus according to the modification of the second embodiment latches the motor winding resistance value.

In this drawing, the effect will be described without considering the dead time of the gate command of the switching element, but the accuracy of the motor winding resistance calculation result can also be improved by performing dead time compensation.

When parameter tuning is started, the current command value gradually increases to a predetermined value. The voltage command value increases while the change rate of the current command value is large, and when the current command value converges to a predetermined value, the voltage command value also converges to the predetermined value. The value of the motor winding resistance R is a value proportional to the voltage command value and inversely proportional to the current command value, and changes so as to have a peak while the current command value and the voltage command value change and then converge to a predetermined value.

In the present modification, the parameter arithmetic unit 107 latches the value of the motor winding resistance R when the change in the value of the motor winding resistance R is smaller than the threshold value and converges to a predetermined value, and uses the value to calculate the inductances L_{d} and L_{q}.

Subsequently, the flag generation unit 108 changes the value of the d/q axis arithmetic flag and raises the arithmetic execution flag. After confirming that the rotor 20 of the synchronous machine M is stopped, as in steps SC2 to SC3 described above, the parameter arithmetic unit 107 starts the arithmetic of the motor parameter for the conduction phase (either the d axis or the q axis) for which a new motor parameter has not been calculated yet.

When the arithmetic completion flag is 1 and the arithmetic of the motor parameters of both the d axis and the q axis is completed, the flag generation unit 108 determines whether the arithmetic of the parameters is completed under all conditions (step SD5). For example, the condition for calculating the motor parameter may be set in the flag generation unit 108 in advance.

In a case where there is a condition under which the motor parameter has not been calculated yet (step SD54, No), the flag generation unit 108 performs the above-described steps SD2 to SD4 for each arithmetic condition to calculate the motor parameter for each of the d axis and the q axis and update the table TB.

In a case where the arithmetic of the motor parameter is completed under all the conditions (step SD5, Yes), the flag generation unit 108 sets the arithmetic execution flag to zero, sets the storage/use flag to zero, and stores the table data output from the parameter arithmetic unit 107 in the table TB. Thereafter, the flag generation unit 108 resets the d/q axis arithmetic flag after the table TB is updated, raises the operation mode flag after a predetermined period (sets the flag to 1), ends the parameter tuning, and starts the normal driving operation of the inverter control apparatus 100.

As described above, in the present modification, the voltage command generation unit 102 retracts and stops the rotor 20 of the synchronous machine M, the flag generation unit 108 confirms the stop of the rotor 20, and at the same time, the parameter arithmetic unit 107 calculates the value of the motor winding resistance R. That is, after calculating the value of the motor winding resistance R, the parameter arithmetic unit 107 can shift to parameter tuning using the calculated motor winding resistance R value. As a result, the parameter arithmetic unit 107 can detect the winding resistance value that changes according to the temperature as a value closer to the actual value, so that the accuracy of the parameter arithmetic can be improved.

That is, according to the inverter control apparatus and the synchronous machine driving apparatus of the present modification, the value of the motor winding resistance R of the synchronous machine M can be measured without using a measuring instrument such as a tester. Specifically, since the winding resistance value of the synchronous machine M has temperature dependency and changes depending on a use environment, a use condition, and the like, it is possible to calculate the motor winding resistance value under a condition closer to the actual operation by calculating the motor winding resistance value as in the present modification, and it is possible to improve the accuracy of the inductance arithmetic itself performed using the arithmetic result.

Note that, in the second embodiment and the modifications thereof described above, the method of applying the DC voltage to the q axis having the maximum inductance when retracting and stopping the synchronous machine M has been used and described, but the synchronous machine M can also be retracted by adopting the method of applying the DC voltage to the d axis. In this case, it is possible to apply by replacing the variable of the calculation used in the case of using the method of retracting to the q axis with the d axis.

Next, an inverter control apparatus and a synchronous machine driving apparatus according to the third embodiment will be described in detail with reference to the drawings.

The present embodiment is different from the first and second embodiments in that the inverter control apparatus 100 applies a DC voltage to both the d axis and the q axis of the synchronous machine M to tune motor parameters. Note that, in a case of searching for an operation point at which the maximum torque is output with the minimum current of the synchronous machine M, it is desirable that the rotor 20 is stopped by an external force because torque is generated. In the following description, it is assumed that the rotor 20 of the synchronous machine M can be fixed by an external force such as a brake or a mechanical mechanism.

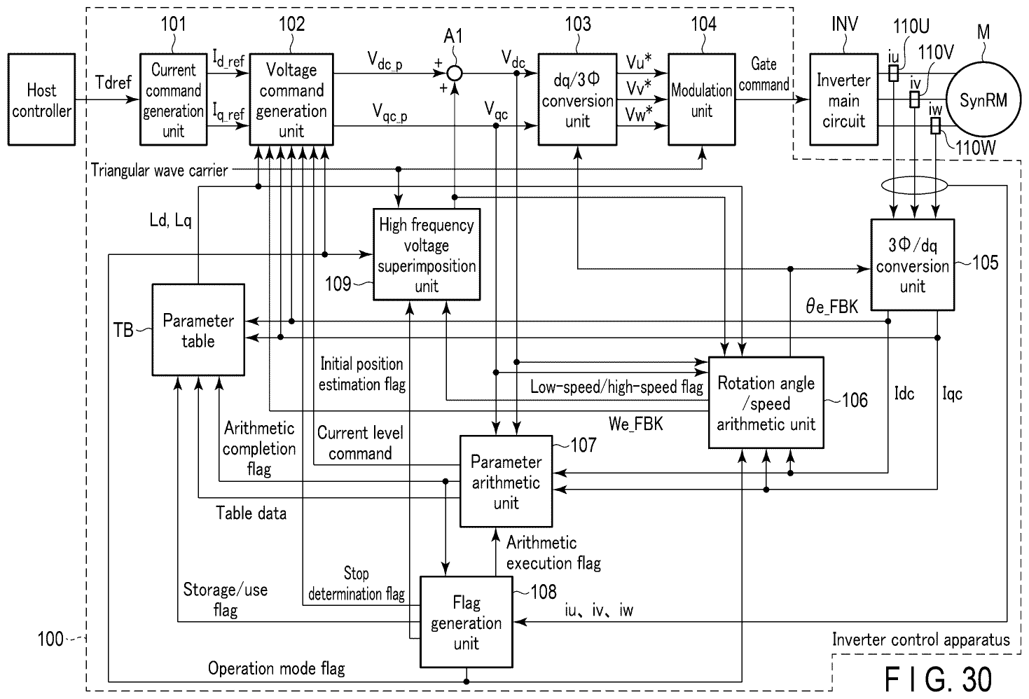

FIG. 30 is a block diagram schematically illustrating a configuration example of an inverter control apparatus and a synchronous machine driving apparatus according to the third embodiment.

In the inverter control apparatus 100, the parameter arithmetic unit 107 inputs a current level command to the voltage command generation unit 102 in order to control the current flowing to the synchronous machine M. In the first embodiment and the second embodiment described above, since the DC voltage is applied to the synchronous machine M and the current nonlinearly increases, the current level is not controlled. The value of the current level command for determining the current amplitude is determined by the parameter arithmetic unit 107 comparing the maximum setting value (final value) of the current flowing through the synchronous machine M at the time of parameter tuning with the values of the d axis current and the q axis current. The current level command is only required to include at least a value indicating a result of comparing the maximum setting value of the current with the d axis current value and the q axis current value, and may be a value indicating a ratio (for example, it is a value of 0% or more and 100% or less according to the resolution of the inductance table to be created, for example, 10%, 20%, 30%, . . . , 100%.) of the flowing current to the maximum setting value.

In the present embodiment, the voltage command generation unit 102 determines the value of the current (current command) to flowing to the synchronous machine M after the motor parameter tuning is started, and calculates the voltage value (voltage command) according to the determined current value.

Assuming that the motor winding resistance load is substantially generated in a case where the synchronous machine M is stopped, the relationship between the current flowing through the synchronous machine M and the voltage is expressed by the following Expression (30).

$${i}_{dq} = \sqrt{{i}_{d}^{2} + {i}_{q}^{2}} = \frac{\sqrt{{v}_{d}^{2} + {v}_{q}^{2}}}{R} = \frac{{v}_{dq}}{R} \qquad ( 30 )$$

where i_{dq} is a dq axis current amplitude, and v_{dq} is a dq axis voltage amplitude.

When the advance of the vector with reference to the d axis is β, the current and the voltage with respect to the motor winding resistance load are expressed by the following Expression (31).

$$\begin{matrix}{i}_{d} = {i}_{dq} \times cos β \\ {i}_{q} = {i}_{dq} \times sin β \\ {v}_{d} = {v}_{dq} \times cos β \\ {v}_{q} = {v}_{dq} \times sin β\end{matrix} \qquad ( 31 )$$

In a case where the inductance is acquired in accordance with a certain operation point of the synchronous machine M, in a case where the current operation point at which the inductance table is to be created is determined, the advance β may be designated according to the current operation point. In a case where the current operation point is not determined, it is necessary to adjust the advance β of the vector and the voltage amplitude v_{dq}.

In the present embodiment, the synchronous machine M is subjected to maximum torque per ampere (MTPA) control so as to obtain the maximum torque output with the minimum current during the normal operation. For example, the voltage command generation unit 102 determines whether the calculated torque value (torque Trq calculated by the following Expression (32)) increases before and after the change of the arithmetic condition of the motor parameter so that an inductance table is created at the operation point at which the maximum torque is output with the minimum current, and adjusts the phase of the voltage command (=the advance β of the vector).

The voltage command generation unit 102 can calculate an inductance according to the current applied to the synchronous machine M. In addition, the voltage command generation unit 102 can calculate the torque Trq using the values of the d axis current and the q axis current as in the following Expression (32).

$${T}_{rq} = {P}_{p} ( {L}_{d\_calc} - {L}_{q\_calc} ) {i}_{d} {i}_{q} \qquad ( 32 )$$

where Pₚ is the number of pole pairs, L_{d_calc} is a d axis inductance calculation value, and L_{q_calc} is a q axis inductance calculation value.

The voltage command generation unit 102 holds and compares the torque Trq that can be calculated by the above Expression (32) before and after changing the arithmetic condition of the motor parameter. The voltage command generation unit 102 advances the phase advance β in a case where the torque Trq exceeds the value by the previous phase command.

In a case where the torque Trq decreases from the previous value (the value based on the previous phase command), it indicates that the maximum torque point has been exceeded. Therefore, the voltage command generation unit 102 stores the motor parameter in the table using the previous value of the current command as the operation point.

In a case where the current level is smaller than the identified value, the parameter arithmetic unit 107 increases the value of the voltage command generated by the voltage command generation unit 102 by adjusting the current level command and executes the above sequence again to create a table of motor parameters.

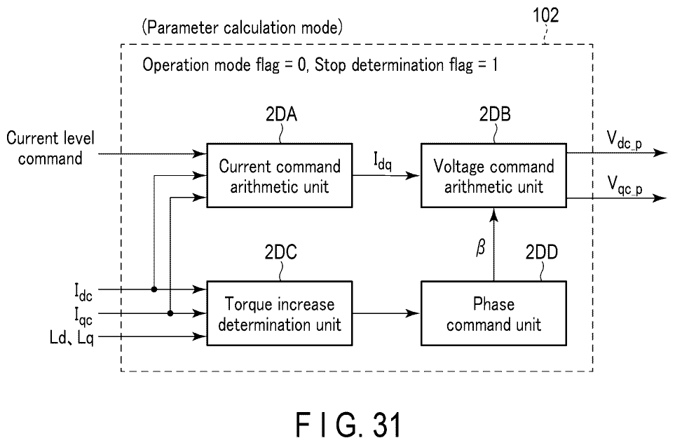

FIG. 31 is a block diagram schematically illustrating a configuration example of a voltage command generation unit illustrated in FIG. 30. The voltage command generation unit 102 includes a current command arithmetic unit 2DA, a voltage command arithmetic unit 2DB, a torque increase determination unit 2DC, and a phase command unit 2DD. The current command arithmetic unit 2DA, the voltage command arithmetic unit 2DB, the torque increase determination unit 2DC, and the phase command unit 2DD operate when the operation mode flag is zero (parameter tuning operation) and the stop determination flag is 1 (stop).

The current command arithmetic unit 2DA calculates and outputs a dq axis current amplitude I_{dq} from the current level command, the d axis current I_{dc} value of the estimation rotation coordinate system, and the q axis current I_{qc} value of the estimation rotation coordinate system. The current level command may include, for example, a result of comparing the maximum setting value of the current with the d axis current value and the q axis current value, or a value indicating a ratio (for example, 10%, 20%, 30%, . . . , 100%) of the flowing current to the maximum setting value. The current command arithmetic unit 2DA can calculate the dq axis current amplitude I_{dq} by the above Expression (30) using the values of the d axis current I_{dc} and the q axis current I_{qc}. In accordance with the value of the current level command, the current command arithmetic unit 2DA may calculate the dq axis current amplitude I_{dq} so that the dq axis current amplitude I_{dq} is a value for searching for an operation point at which the maximum torque/minimum current of the synchronous machine M is obtained under another condition (for example, current increase).

The torque increase determination unit 2DC calculates the torque Trq from the d axis current I_{dc} value of the estimation rotation coordinate system, the q axis current I_{qc} value of the estimation rotation coordinate system, and the values of the inductances L_{d} and L_{q} by the above Expression (32) to output a value indicating a result of determining whether the value of the torque Trq has increased from the previous value.

The phase command unit 2DD outputs a phase command to advance the advance β of the phase from the output value of the torque increase determination unit 2DC in a case where the torque Trq exceeds the previous value. In a case where the torque Trq decreases from the previous value, it indicates that the maximum torque point has been exceeded, so that the voltage command generation unit 102 outputs the phase command so that the previous value of the current command is the operation point.

The voltage command arithmetic unit 2DB calculates the values of the d axis voltage command and the q axis voltage command by the above Expression (30) and Expression (31) using the values of the dq axis current amplitude I_{dq} calculated by the current command arithmetic unit 2DA and the phase command calculated by the phase command unit 2DD.

The voltage command generation unit 102 sets the amplitude of the flowing current to a value determined by the resolution of the inductance table (the value of the current level command), fixes the amplitude of the voltage to a value calculated from the current flowing to the synchronous machine and the motor winding resistance R, changes the phase of the flowing current by changing the voltage phase, and searches for a maximum torque point, a maximum power factor point to be described later, and the like.

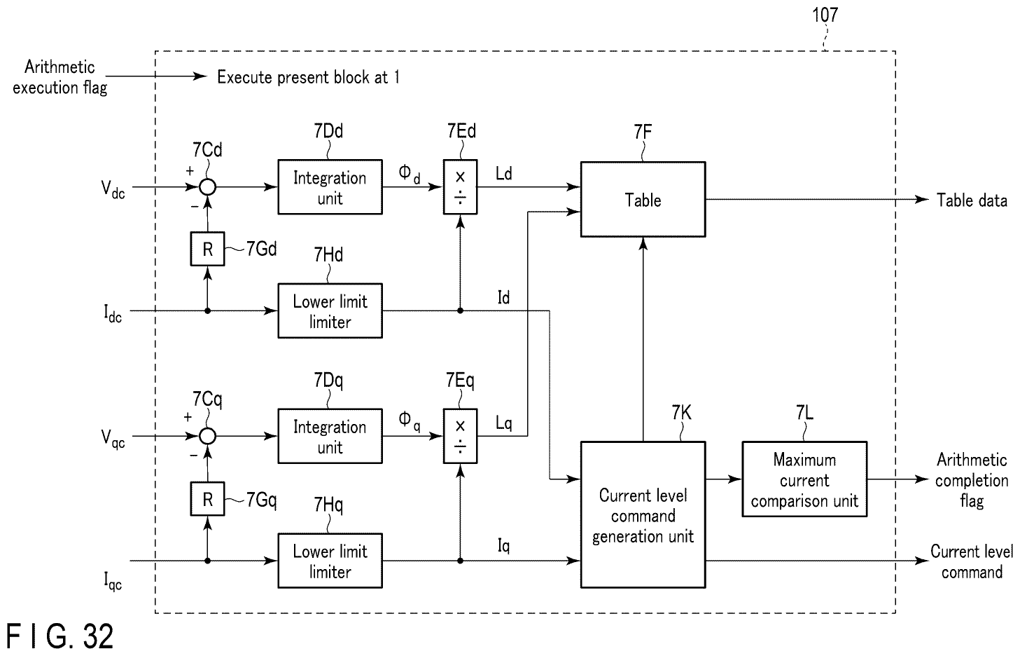

FIG. 32 is a block diagram schematically illustrating a configuration example of a parameter arithmetic unit illustrated in FIG. 30.

In the present embodiment, the parameter arithmetic unit 107 can simultaneously calculate motor parameters (inductances) of both the d axis and the q axis.

The parameter arithmetic unit 107 includes subtraction units 7Cd and 7Cq, integration units 7Dd and 7Dq, division units 7Ed and 7Eq, a table 7F, resistance value multiplication units 7Gd and 7Gq, lower limit limiters 7Hd and 7Hq, a current level command generation unit 7K, and a maximum current comparison unit 7L.

The resistance value multiplication unit 7Gd calculates a product obtained by multiplying the d axis current I_{dc} value by the value of the motor winding resistance R, and supplies the calculation result to the subtraction unit 7Cd.

The subtraction unit 7Cd calculates a difference obtained by subtracting the output value of the resistance value multiplication unit 7Gd from the d axis voltage V_{dc} value, and supplies a calculation result to the integration unit 7Dd.

The integration unit 7Dd integrates the output value (V_{dc}−R×I_{dc}) of the subtraction unit 7Cd to calculate the value of the magnetic flux Φ corresponding to the above Expressions (20) and (21), and supplies the magnetic flux Φ to the division unit 7Ed.

The lower limit limiter 7Hd sets a lower limit value (>zero) of the d axis current I_{dc} value, outputs the input value I_{dc} as the current value I_{d} in a case where a value I_{dc} equal to or greater than the lower limit value is input, and outputs the lower limit value as the current value I_{d} in a case where a value I_{dc} less than the lower limit value is input. As a result, the output value I_{d} of the lower limit limiter 7Hd is a value larger than zero, and zero division in the division unit 7Ed can be avoided.

The division unit 7Ed calculates a quotient obtained by dividing the value of the magnetic flux Φ output from the integration unit 7Dd by the current value I_{d} output from the lower limit limiter 7Hd, and supplies the inductance value L_{d} corresponding to the above Expressions (24) and (25) to the table 7F.

The resistance value multiplication unit 7Gq calculates a product obtained by multiplying the q axis current I_{qc} value by the value of the motor winding resistance R, and supplies the calculation result to the subtraction unit 7Cq.

The subtraction unit 7Cq calculates a difference obtained by subtracting the output value of the resistance value multiplication unit 7Gq from the q axis voltage V_{qc} value, and supplies a calculation result to the integration unit 7Dq.

The integration unit 7Dq integrates the output value (V_{qc}−R×I_{qc}) of the subtraction unit 7Cq to calculate the value of the magnetic flux Φ corresponding to the above Expressions (20) and (21), and supplies the magnetic flux Φ to the division unit 7Eq.

The lower limit limiter 7Hq sets a lower limit value (>zero) of the q axis current I_{qc} value, outputs the input value I_{qc} as the current value I_{q} in a case where a value I_{qc} equal to or larger than the lower limit value is input, and outputs the lower limit value as the current value I_{q} in a case where a value I_{qc} less than the lower limit value is input. As a result, the output value I_{q} of the lower limit limiter 7Hq is a value larger than zero, and zero division in the division unit 7Eq can be avoided.

The division unit 7Eq calculates a quotient obtained by dividing the value of the magnetic flux Φ output from the integration unit 7Dq by the current value I_{q} output from the lower limit limiter 7Hq, and supplies the inductance value L_{q} corresponding to the above Expressions (24) and (25) to the table 7F.

The current level command generation unit 7K outputs a sampling signal corresponding to the timing at which the table 7F stores the inductance values L_{d} and L_{q} according to the output value I_{d} of the lower limit limiter 7Hd and the output value I_{q} of the lower limit limiter 7Hq. Since the current values I_{d} and I_{q} are controlled so as to return to the previous values in a case where the maximum torque of the synchronous machine M is exceeded, the current level command generation unit 7K, for example, monitors the current values I_{d} and I_{q} to output a sampling signal so as to sample the values of the inductances L_{d} and L_{q} calculated at the timing in a case where the current values I_{d} and I_{q} return to the previous values. The current level command generation unit 7K may acquire the determination result of the torque increase determination unit 2DC of the voltage command generation unit 102, and output the sampling signal in which the previous values of the inductances L_{d} and L_{q} are stored in the table 7F according to the determination result that the torque is increased.

The current level command generation unit 7K may output a current level command according to a comparison result obtained by comparing the current values I_{d} and I_{q} at the timing of sampling the inductance L_{d} and L_{q} values with the maximum setting value. In a case where the current values I_{d} and I_{q} are smaller than the maximum setting value, the current level command generation unit 7K may generate and output a current level command indicating that the maximum setting value has not been reached (or the next current level). In a case where the current values I_{d} and I_{q} are equal to or larger than the maximum setting value, the current level command generation unit 7K may generate and output a current level command indicating that the maximum setting value has been reached (or the condition for parameter calculation is changed).

The current level command generation unit 7K also supplies the values of the current values I_{d} and I_{q} to the maximum current comparison unit 7L.

The maximum current comparison unit 7L compares the current values I_{d} and I_{q} with the maximum setting value, determines whether there is a condition under which the inductances L_{d} and L_{q} are not calculated in a case where the current values I_{d} and I_{q} reach the maximum setting value, and in a case where the calculation of the inductances L_{d} and L_{q} is completed under all the conditions, sets the arithmetic completion flag from zero to 1 to output the arithmetic completion flag to the flag generation unit 108 and the parameter table TB. In each condition, when the current values I_{d} and I_{q} reach the maximum setting value and the arithmetic completion flag changes from zero to 1, the parameter calculation of the parameter arithmetic unit 107 is completed.

The table 7F stores a relationship between the current value I_{d}-inductance value L_{d} and the current value I_{q}-inductance value L_{q} according to the sampling signal. When the storage of the inductance values L_{d} and L_{q} corresponding to the current values I_{d} and I_{q} 100% is completed, the table 7F outputs table data of the inductance values L_{d} and L_{q} corresponding to the current values I_{d} and I_{q} 10% to 100% to the parameter table TB.

The parameter table TB receives table data from the parameter arithmetic unit 107, and when the arithmetic completion flag changes from zero to 1, the parameter table TB updates the value of the motor parameter with new table data. In the present embodiment, since the parameter arithmetic unit 107 supplies the table data including the inductance L_{d} and L_{q} values of both the d axis and the q axis to the parameter table TB, the value of the d/q axis arithmetic flag can be omitted from being supplied to the parameter table TB.

Next, an example of operation of the inverter control apparatus and the synchronous machine driving apparatus according to the present embodiment will be described.

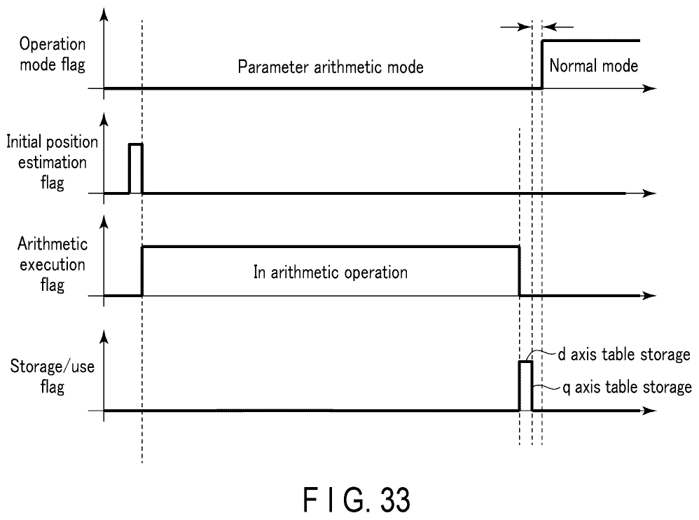

FIG. 33 is a diagram schematically illustrating an example of flags generated by a flag generation unit illustrated in FIG. 30.

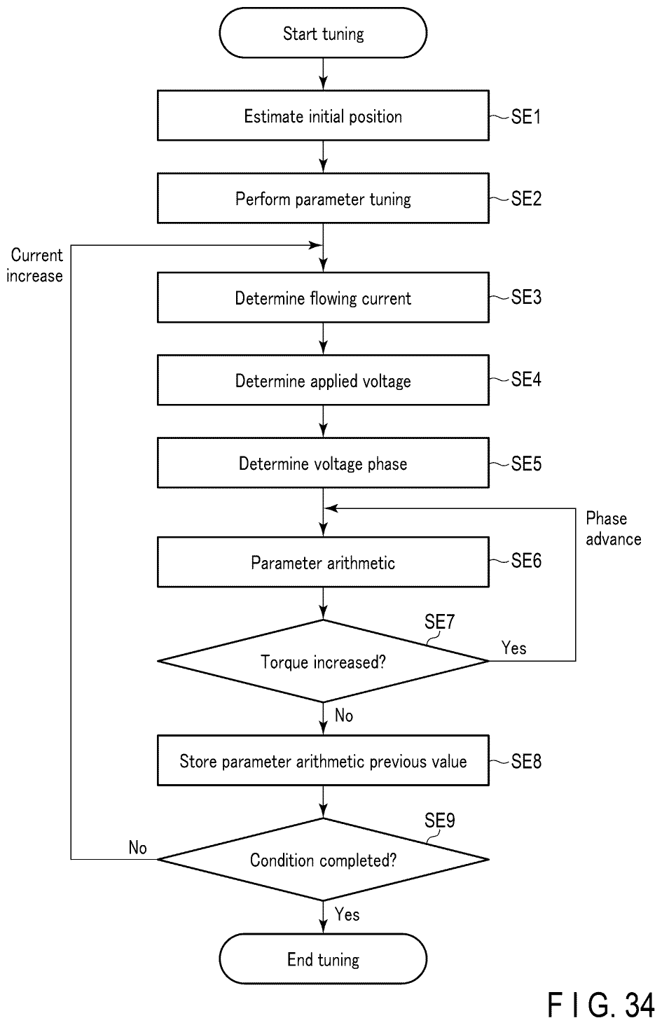

FIG. 34 is a flowchart illustrating an example of the operation of the inverter control apparatus and the synchronous machine driving apparatus according to the third embodiment.

When the operation mode flag changes from 1 to zero, the inverter control apparatus 100 switches from the normal driving to the operation of parameter tuning. When parameter tuning is started, the flag generation unit 108 raises an initial position estimation flag.

While the initial position estimation flag rises, the high frequency voltage command Vₕ is output from the high frequency voltage superimposition unit 109, and the high frequency voltage command Vₕ is superimposed on the d axis voltage command V_{dc_p}.

For example, the rotation angle/speed arithmetic unit 106 calculates the rotation phase angle error Δθ by the above Expression (10) or (10)′, and performs PLL control so that the rotation phase angle error Δθ converges to zero, thereby calculating the estimated value ωₑ_FBK of the rotation angular velocity and the estimated value θₑ_FBK of the rotation phase angle to estimate the initial position (step SE1).

Subsequently, the rotation determination unit 8A acquires the estimated value θₑ_FBK of the rotation phase angle calculated by the rotation angle/speed arithmetic unit 106, compares the latest value of the estimated value θₑ_FBK of the rotation phase angle with the previous value, and generates and outputs the value of the stop determination flag indicating whether the rotor of the synchronous machine M is stopped.

At this time, the rotation determination unit 8A determines that the rotor 20 of the synchronous machine M is rotating when the difference between the latest value and the previous value of the estimated value θₑ_FBK of the rotation phase angle is greater than or equal to a predetermined threshold value, maintains the stop determination flag at zero until the difference between the latest value and the previous value is less than the predetermined threshold value, and repeats steps SA1 to SA3.

When the difference between the latest value and the previous value of the estimated value θₑ_FBK of the rotation phase angle is less than a predetermined threshold value, the rotation determination unit 8A determines that the rotor of the synchronous machine M is stopped and sets the stop determination flag to 1 (stop).

In the present embodiment, since the rotor 20 of the synchronous machine M is stopped by an external force, the rotation determination unit 8A confirms the stop of the synchronous machine M for confirmation before performing parameter tuning.

When the stop determination flag changes from zero to 1, parameter tuning is executed (step SE2).

When the operation mode flag is zero and the stop determination flag is 1, the current command arithmetic unit 2DA of the voltage command generation unit 102 calculates the amplitude I_{dq} of the current flowing to the synchronous machine M using the d axis current I_{dc} and the q axis current I_{qc} (step SE3).

Subsequently, the voltage command arithmetic unit 2DB of the voltage command generation unit 102 calculates the voltage amplitude v_{dq} by the above Expression (30) using the current amplitude I_{dq} and the value of the motor winding resistance R (step SE4). The voltage command generation unit 102 calculates and outputs the voltage commands V_{dc_p} and V_{qc_p} by the above Expression (31) using the phase β acquired from the phase command unit 2DD (step SE5). A DC voltage is applied to the synchronous machine M by the voltage commands V_{dc_p} and V_{qc_p}.

The parameter arithmetic unit 107 calculates the inductances L_{d} and L_{q} using the voltage commands V_{dc_p} and V_{qc_p} and the flowing current values I_{dc} and I_{qc} (step SE6).

While the torque Trq of the synchronous machine M increases (step SE7, Yes), the voltage command generation unit 102 advances the phase β to calculate and output the voltage commands V_{dc_p} and V_{qc_p}. When the torque Trq of the synchronous machine M decreases (step SE7, No), the voltage command generation unit 102 calculates and outputs the voltage commands V_{dc_p} and V_{qc_p} with the phase β as the previous value.

The parameter arithmetic unit 107 samples the calculated values of the inductances L_{d} and L_{q} at the timing when the torque Trq decreases (the timing when the phase of the current is the previous value) and generates table data in which the sampled values are stored (step SE8).

The parameter arithmetic unit 107 determines whether the parameter calculation has been completed for all the conditions for calculating the parameters (step SE9). For example, in a case where the current values I_{dc} and I_{qc} to the synchronous machine M do not reach the maximum setting value (step SE9, No), the parameter arithmetic unit outputs a current level command to the voltage command generation unit 102 so as to increase the flowing current (increase the current). In a case where the parameter calculation is completed for all the conditions (step SE9, Yes), the parameter arithmetic unit 107 outputs the table data and sets the arithmetic completion flag from zero to 1 to end the parameter arithmetic.

In the third embodiment described above, the example in which the inverter control apparatus 100 searches for the maximum torque/minimum current point of the synchronous machine M is described. This may be configured to observe the power factor. In a case where the power factor is calculated, it is necessary to assume the rotation speed. For example, when the angular velocity ω_{e_n}, the d axis voltage v_{dn}, the q axis voltage v_{qn}, the d axis current I_{dn}, and the q axis current i_{qn} at the rated rotation speed are set, the voltage equation of the SynRM can be expressed by the following Expression (33).

$$[ \begin{matrix}{v}_{dn} \\ {v}_{qn}\end{matrix} ] = [ \begin{matrix}R & - {ω}_{e\_n} {L}_{q\_calc} \\ {ω}_{e\_n} {L}_{q\_calc} & R\end{matrix} ] [ \begin{matrix}{i}_{dn} \\ {i}_{qn}\end{matrix} ] \qquad ( 33 )$$

From the above Expression (33), the power factor Pn can be calculated as follows.

$${P}_{n} = {v}_{dn} {i}_{dn} + {v}_{qn} {i}_{qn} \qquad ( 34 )$$

As in the case of the torque, the voltage command generation unit 102 may adjust the phase advance β so that the power factor Pn of the above Expression (34) is maximized. Furthermore, in a case where an operation point between the maximum torque/minimum current point and the maximum power factor point is taken as an operation point at which the motor parameter is sampled, values obtained by weighting the difference from the best operation point are added, and a point at which the sum is minimum may be searched for. At this time, processing of obtaining the optimum point may be performed using the least squares method or the like instead of the simple sum, and any other method may be applied as long as the optimum point can be searched for.

According to the present embodiment, as in the first and second embodiments described above, it is possible to provide an inverter control apparatus and a synchronous machine driving apparatus that suppress deterioration in reliability and comfort.

According to the inverter control apparatus and the synchronous machine driving apparatus according to the third embodiment, the motor parameter can be tuned in a case where the motor parameter (inductance) at an any operation point such as an actual operation point is used. Further, in the inverter control apparatus and the synchronous machine driving apparatus according to the third embodiment, at the time of parameter tuning, by energizing both the d axis and the q axis, a parameter value considering mutual interference between the d axis and the q axis can be acquired, and a more accurate inductance table can be acquired.

The program according to the present embodiment may be transferred in a state of being stored in the electronic device, or may be transferred in a state of not being stored in the electronic device. In the latter case, the program may be transferred via a network or may be transferred in a state of being stored in a storage medium. The storage medium is a non-transitory tangible medium. The storage medium is a computer-readable medium. The storage medium may be any medium that can store a program such as a CD-ROM or a memory card and can be read by a computer, and its form is not limited.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An inverter control apparatus comprising:
a voltage command generation unit that generates a voltage command to be applied to a synchronous machine;
a current detection unit that detects a current flowing from an inverter main circuit driven by a gate command based on the voltage command to the synchronous machine;
a flag generation unit that switches between a motor parameter tuning operation and a normal driving operation; and
a parameter arithmetic unit that calculates a motor parameter using a value of the voltage command and a detection value of the current detection unit at a time of a motor parameter tuning operation, wherein
the voltage command generation unit generates the voltage command to apply a DC voltage to the synchronous machine at a time of motor parameter tuning operation.

2. The inverter control apparatus according to claim 1, wherein the voltage command generation unit generates the voltage command to apply the DC voltage to a d axis or a q axis of the synchronous machine as a target.

3. The inverter control apparatus according to claim 1, wherein the voltage command generation unit generates the voltage command to flow a current to a conduction phase, of the synchronous machine, that most easily generates a magnetic flux, and retracts and stops a rotor of the synchronous machine at a predetermined angle.

4. The inverter control apparatus according to claim 1, wherein
the voltage command generation unit generates the voltage command to apply the DC voltage to a d axis and a q axis of the synchronous machine as a target, and
an amplitude and a phase of the voltage command are determined using at least one of torque and a power factor of the synchronous machine as an index.

5. The inverter control apparatus according to claim 1, wherein the parameter arithmetic unit continues to calculate the motor parameter until the motor parameter corresponding to a current according to a rated current of the synchronous machine is acquired.

6. The inverter control apparatus according to claim 1, wherein the voltage command generation unit determines a maximum value of the voltage command using a rated current and a motor winding resistance value of the synchronous machine.

7. The inverter control apparatus according to claim 1, wherein
the flag generation unit determines whether a rotor of the synchronous machine is stopped using a current value supplied to the synchronous machine, and
switches to execute calculation of the motor parameter in response to determination that the rotor of the synchronous machine is stopped.

8. The inverter control apparatus according to claim 1, wherein
the motor parameter includes a motor winding resistance value of the synchronous machine, and
the motor winding resistance value is a quotient obtained by dividing a value corresponding to a DC voltage applied to the synchronous machine by a value corresponding to a current supplied to the synchronous machine.

9. The inverter control apparatus according to claim 1, wherein
the motor parameter includes an inductance of the synchronous machine, and
the parameter arithmetic unit calculates a magnetic flux value generated by applying a DC voltage to the synchronous machine, and calculates the inductance by dividing the magnetic flux value by a value corresponding to a current supplied to the synchronous machine.

10. A synchronous machine driving apparatus comprising:
a voltage command generation unit that generates a voltage command to be applied to a synchronous machine;
an inverter main circuit driven by a gate command based on the voltage command;
a current detection unit that detects a current flowing from the inverter main circuit to the synchronous machine;
a flag generation unit that switches between a motor parameter tuning operation and a normal driving operation; and
a parameter arithmetic unit that calculates a motor parameter using a value of the voltage command and a detection value of the current detection unit at a time of a motor parameter tuning operation, wherein
the voltage command generation unit generates the voltage command to apply a DC voltage to the synchronous machine at a time of motor parameter tuning operation.

11. The synchronous machine driving apparatus according to claim 10, wherein the voltage command generation unit generates the voltage command to apply the DC voltage to a d axis or a q axis of the synchronous machine as a target.

12. The synchronous machine driving apparatus according to claim 10, wherein the voltage command generation unit generates the voltage command to flow a current to a conduction phase, of the synchronous machine, that most easily generates a magnetic flux, and retracts and stops a rotor of the synchronous machine at a predetermined angle.

13. The synchronous machine driving apparatus according to claim 10, wherein
the voltage command generation unit generates the voltage command to apply the DC voltage to a d axis and a q axis of the synchronous machine as a target, and
an amplitude and a phase of the voltage command are determined using at least one of torque and a power factor of the synchronous machine as an index.

14. The synchronous machine driving apparatus according to claim 10, wherein the parameter arithmetic unit continues to calculate the motor parameter until the motor parameter corresponding to a current according to the rated current of the synchronous machine is acquired.

15. The synchronous machine driving apparatus according to claim 10, wherein the voltage command generation unit determines a maximum value of the voltage command using a rated current and a motor winding resistance value of the synchronous machine.

16. The synchronous machine driving apparatus according to claim 10, wherein
the flag generation unit determines whether a rotor of the synchronous machine is stopped using a current value supplied to the synchronous machine, and
switches to execute calculation of the motor parameter in response to determination that the rotor of the synchronous machine is stopped.

17. The synchronous machine driving apparatus according to claim 10, wherein
the motor parameter includes a motor winding resistance value of the synchronous machine, and
the motor winding resistance value is a quotient obtained by dividing a value corresponding to a DC voltage applied to the synchronous machine by a value corresponding to a current supplied to the synchronous machine.

18. The synchronous machine driving apparatus according to claim 10, wherein
the motor parameter includes an inductance of the synchronous machine, and
the parameter arithmetic unit calculates a magnetic flux value generated by applying a DC voltage to the synchronous machine, and calculates the inductance by dividing the magnetic flux value by a value corresponding to a current supplied to the synchronous machine.
